(19) United States
(12) Patent Application Publication
(10) Pub. No.: US 2017/0081853 A1
(43) Pub. Date: Mar. 23, 2017

(54) REBAR CONNECTOR HAVING A PAIR OF LOCKING PIECES AND CONNECTION METHOD FOR PREFABRICATED REBAR NET USING SAME

(71) Applicant: Yong-Keun KIM, Incheon (KR)

(72) Inventor: Yong-Keun KIM, Incheon (KR)

(21) Appl. No.: 15/311,513

(22) PCT Filed: May 13, 2015
(86) PCT No.: PCT/KR2015/004791

§ 371 Date: Nov. 15, 2016

(30) Foreign Application Priority Data
May 21, 2014 (KR) 10-2014-0060886

(51) Int. Cl. E04C 5/16; E04C 5/18; F16B 7/18; E04C 5/01

(52) U.S. Cl. CPC E04C 5/165; E04C 5/01; E04C 5/18; F16B 7/182

(57) ABSTRACT

A rebar connector having a pair of locking pieces includes: a first rebar and a second rebar to be connected to each other; a first connecting member having a center hole, receiving the first rebar from a first side, having a first coupling hole at a second side, and having a threaded portion on the outer side; a second connecting member having a center hole, receiving the second rebar through a first side, and having a second coupling hole at a second side; a first locking piece coupled to the first coupling hole; a second locking piece coupled to the second coupling hole; and a locking socket locked at a predetermined position on the second connecting member, covering an outer side of the second connecting member, and having a female threaded portion on an inner side to be thread-fastened to the male threaded portion of the first connecting member.

### TECHNICAL FIELD

The present invention relates to a rebar connector having a pair of locking members and, more particularly, to a rebar connector that can be used to connect single rebars and prefabricated rebar nets without initial slip at a joint, does not need to be filled with grout, and corrects the inclination of one of the prefabricated rebar nets.

### Background Art

In the related art, a coupler for steel bars has been disclosed in Japanese Patent Laid-Open Publication No. 6-158783. The coupler has female threads to be thread-fastened to male threads on the inner side and connects a pair of steel bars each having male threads at connection ends, in which the gaps between the female threads of the coupler and the male threads of the steel bars comprise half of the thread pitches.

The reason that the female thread pitches of the coupler are increased to over half of the thread pitches is for absorbing position differences between the male threads on the steel bars and the female threads on the coupler. However, the pitches of the female threads on the inner side of the coupler are over half of the thread pitches of the male threads on the steel bars to be connected, so when the steel bars are connected by the coupler, large gaps are generated between the threads. Accordingly, the steel bars cannot be precisely connected and initial slip is necessarily generated between the steel bars and the coupler by tension even after they are combined.

Further, due to the difference of a half in the thread pitches, the grooves are expanded and the sizes in the width direction of the ridges of the threads are reduced, that is, the grooves are expanded and the width of the ridges are reduced, so the threads cannot resist tensile force or compressive force, and accordingly, the threads are not suitable for a coupler and the joint is weak.

In order to solve this problem, couplers are increased in length so that at least six or more threads of a threaded-rebar are fastened to a side, that is, a total of twelve or more threads are fastened.

Further, there is a method of tightening locking nuts, which are thread-fastened to male threads on steel bars, to both ends of a coupler. However, the locking nuts and the coupler that connects steel bars both resist tension, but only the locking nuts resist compression, so the joint is inherently weak.

Further, including prefabricated rebar nets, single threaded rebars should be spaced at the ends to absorb position differences of the threads when the rebars are connected by a coupler, in which the ends of the threaded rebars can be connected to both ends by turning up or down any one of the threaded rebars. Accordingly, the ends of the rebars are spaced in the coupler even after they are combined. Therefore, this structure is vulnerable to axial compression and vibration stress, so it is required to fill the coupler with grout in order to reinforce the structure.

There has been proposed a method of filling the gap between the coupler and the rebars with grout. Grout for a threaded rebar coupler and a threaded rebar coupler have been disclosed in Japanese Patent Laid-Open Publication No. 4-76148. According to this document, grout for a threaded rebar coupler is injected into the joint of a coupler and a threaded rebar and then hardened therein, thereby showing compressive strength of 900 kgf/cm², a modulus of elasticity of 1.5×105 kgf/cm², and a volume shrinkage rate of 4%.

However, when grout is filled in the joint of rebars, the rebars are tensile members and the grout at the joint is a compressive member, so the joint is likely to be weak due to the contrast characteristics of the materials. Further, a material having tensile strength against external force, particularly, tensile force is suitable for the joint of the coupler and a material having compressive strength is not suitable for mechanical coupling. Further, the compressive strength of the grout is 9 kgf/mm² and SD600 rebars have tensile strength of about 72 kgf/mm², so there is an eight-fold rigidity difference to a base material.

Further, when grout is filled in the joint of rebars, tension of 125% or more of the yield strength of the rebars is transmitted, so, according to “Comuarative Evaluation on Strength of Several Grout-filled Splice Sleeve”, in order to satisfy KS D 0249, the mounting length of a rebar should be 4.5 d or more when the compressive strength of grout is 70 MPa (about 713 kgf/cm²) or more, and should be 3.9 d or more when the compressive strength is 80 MPa (about 815 kgf/cm²) or more. That is, although there are differences in compressive strength of grouts, it is required to secure a mounting length that is about four the four and a half times the diameter of a rebar, so the length of the joint is necessarily increased.

In the related art, structures having high structural stability and a soundproof ability by employing Rahmen in methods of constructing buildings having the wall structures of houses have been developed, but for these structures, there was a need for method of assembling necessarily prefabricated rebar nets, not single rebars, at site.

According to this method, it is very important to not only use high-strength rebars, but precisely connect the rebars with a rebar coupler, but in the former construction field, they have not yet moved past the method of loosely connecting high-strength threaded rebars with the coupler that thread-fastens rebars, tightening locking pieces to both ends of the coupler, and then filling the coupler with grout.

In order to connect prefabricated rebar nets using the coupler that thread-fastens rebars, first, the couplers are coupled to ends of an upper prefabricated rebar net and turned upward, and then turned down to be fastened to lower prefabricated rebar nets, thereby connecting the upper and lower prefabricated rebar nets. However, when the ends of the rebars are bent or burrs or cusps are formed in the process of cutting the rebars, it is difficult to thread-fasten the couplers and absorb position difference between the threads, and the prefabricated rebar nets are deformed by their own weight while they are transported. Further, even though they are manufactured using a jig, dimensional errors are necessarily generated at the ends of the rebars. Accordingly, it is inherently very difficult to axially fit the ends of the rebars in the couplers.

Further, even if they are axially fitted, it is impossible to use the existing couplers in order to correct verticality of the prefabricated rebar nets that are not firmly connected by turning up or down the coupler in which gaps comprise over a half of the thread pitches, and it is also difficult to perform a specific process for securing the verticality.

Therefore, the verticality of prefabricated rebar nets, which are composed of longitudinal rebars for a pillar, cannot be secured, so it is correspondingly difficult to mount longitudinal rebars for a beam and longitudinal rebars for a wall thereon.

In order to solve the problems, the present invention provides a rebar connector that can be used to connect single rebars, including threaded rebars, and prefabricated rebar nets without initial slip at a joint, does not need to be filled with grout, and corrects the inclination of one of the prefabricated rebar nets.

### DISCLOSURE

### Technical Problem

An object of the present invention is to prevent initial slip by moving and rearranging locking nuts at both ends to the center in a method of tightening both ends of a coupler with the locking nuts.

Another object of the present invention is to provide spaces for absorbing displacement generated by pulling force for removing initial slip of a first rebar and a second rebar.

Another object of the present invention is to integrate a joint with initial slip prevented against axial tensile force and compressive force.

Another object of the present invention is to provide various shapes for axially fitting a first rebar and a second rebar to be connected, connect not only single rebars, but prefabricated rebar nets, and connect not only vertical rebars, but horizontal rebars.

Another object of the present invention is to axially fit a first rebar and a second rebar to be connected and prevent initial slip of the first rebar and the second rebar in a joint using one member.

Another object of the present invention is to provide rigidity to a joint against axial compressive force without filling a coupler with a filler such as grout.

Another object of the present invention is to correct various construction errors at site when connecting not only single rebars, but prefabricated rebar nets.

Another object of the present invention is to precisely connect prefabricated rebars by adjusting the inclination of one of the prefabricated rebar nets in front-rear, orthogonal, and left-right directions.

### Technical Solution

A rebar connector having a pair of locking pieces according to an aspect of the present invention includes: a first rebar and a second rebar to be connected to each other with ends fitted to each other; a first connecting member having a center hole, receiving the first rebar into the center hole from a first side, having a first coupling hole at a second side, and having a male threaded portion at a predetermined section on an outer side thereof; a second connecting member having a center hole, receiving the second rebar into the center hole through a first side, and having a second coupling hole at a second side; a first locking piece separately formed and coupled to the first coupling hole; a second locking piece separately formed and coupled to the second coupling hole; and a locking socket locked at a predetermined position on the second connecting member, covering an outer side of the second connecting member, and having a female threaded portion on an inner side to be thread-fastened to the male threaded portion of the first connecting member, in which an integrated joint is formed by tightening the locking socket with the first locking piece and the second locking piece fitted to each other as a pair.

The first locking piece and the second locking piece to be fitted to each other each may have a body, a front end formed at a first end of the body, and a base end formed at a second end of the body, in which the base end may be inserted in the first coupling hole or the second coupling hole and the front ends are fitted to each other.

The first coupling hole and the second coupling hole respectively may have a first space and a second space for absorbing displacement of the first connecting member and the second connecting member when the locking socket is tightened.

The first space and the second space may communicate with the center holes, and sizes of the first space and the second space may depend on a coupling length of the first and second connecting members and the first and second rebars.

The front ends of the first locking pieces and the second locking pieces to be fitted to each other may be flat surfaces perpendicular to an axial direction, or may be a projection and a recession corresponding to the projection, respectively.

The projection at the front end and the recession corresponding to the projection may be: a multi-stepped inclined projection having a one or more of uniform sections and inclined sections longitudinally formed on an outer side and a recession corresponding to the multi-stepped inclined projection; or a multi-stepped rectangular projection having a one or more of uniform sections and inclined sections longitudinally formed on an outer side and having an end being parallel with an axial direction, and a recession corresponding to the multi-stepped rectangular projection; or a multi-stepped curved projection having a one or more of uniform sections and inclined sections longitudinally formed on an outer side and having a rounded end, and a recession corresponding to the multi-stepped curved projection; or a projection having a shape selected from shapes of a cone, a frustum-cone, a cone with a rounded top, a cylinder, a polypyramid, a frustum-polyprism, a polyprism with a rounded top, a polygonal cylinder, a sphere, an elliptical sphere, a frustum-spherical shape, a frustum-elliptical sphere, a triangle, a triangle with a rounded top, a rectangle, and a rectangle with rounded edges, and a shape having an end on which a cross, a combination of a cross and a circle, or a waved colgate is formed, and a recession corresponding to the projection.

The recession may be an axially formed through-hole.

The base ends of the first locking piece and the second locking piece may be inserted in the first coupling hole and the second coupling hole and loosely positioned in the first space and the second space.

A second projection may be formed on the bodies of the first locking piece or the second locking piece outward from the first space and the second space to limit an insertion depth of the first locking piece or the second locking piece, and may be spaced from the front ends of the first connecting member and the second connecting member to define a first gap and a second gap that adjust a length of the joint or remove initial slip.

A step for locking the first projections at the base ends of the first locking piece and the second locking piece may be formed inside the first space and the second space, and may be one or more bolts.

The loosely positioned base ends of the first locking piece and the second locking piece may be pressed at predetermined positions by front ends of the first rebar and the second rebar.

The base ends of the first locking piece and the second locking piece may be inserted in the center holes of the first connecting member and the second connecting member and pressed by front ends of the first rebar and the second rebar to be fitted to the first space and second space and the front ends of the first rebar and the second rebar.

First female threads may be formed on inner sides of inlets of the first space and the second space, first male threads may be formed at a predetermine section on outer sides of the first locking piece and the second locking piece, and the first male threads may be inserted and thread-fastened in the inlets.

The first locking piece and the second locking piece may be pressed between the first female threads on the inner sides of the inlets and the front ends of the first rebar and the second rebar.

The inner sides of the inlets of the first space and the second space and the base ends of the first locking piece and the second locking piece each may have a tolerance, and the base ends of the first locking piece and the second locking piece may be forcibly fitted in the inlets.

A mark for showing a primary insertion position may be formed at a predetermined position on the base ends of the first locking piece and the second locking piece.

Prominences and depressions may be formed on the inner side of the inlet of the first space or the second space.

Torque that is applied to tighten the locking socket may change a circumferential position of the locking socket and move the first connecting member and the second connecting member to each other, displacement of the first connecting member and the second connecting member may be absorbed by the first gap and the second gap, and the joint may be formed with initial slip absorbed by the first gap and the second gap, thereby preventing initial slip of the joint.

The first locking piece and the second locking piece may align axes of the first rebar and the second rebar and prevent initial slip of the first rebar and the second rebar in the joint.

The first rebar and the second rebar may be threaded rebars, and female threaded portions for coupling the threaded rebars may be formed in the center holes of the first connecting member and the second connecting member, respectively.

A female threaded portion for coupling a connecting member may be formed in the center holes of the first connecting member and the second connecting member, the first rebar and the second rebar may be deformed steel bars, and the male threaded portion for coupling a connecting member may be formed by any one of forming set threads through form rolling after swaging at the end of the deformed steel bar, forming cut threads through cutting, or attaching a threaded connection member that is separately formed.

A first locking step having one or more steps may be formed at the predetermined position on the second connecting member where the locking socket is locked, a second locking step having one or more steps to be locked to the first locking step may be formed on the inner side of the locking socket, and the steps having one or more steps may be formed with an acute angle, a right angle, or an obtuse angle, or are curved with a predetermined curvature.

A portion for preventing slide and allowing for easily holding with a hand may be formed on the outer sides of the first connecting member, the second connecting member, and the locking socket, and the portion for preventing slide may include any one of cases when a spline is formed on the outer sides, the outer sides are knurled, the cross-sections are formed in a circle, the cross-section is formed in a polygon, a holding surface is formed at one or more positions facing each other.

The male threaded portion, the female threaded portion, the first female threads, the male threads, the male threaded portion for coupling a connecting member, and the female threaded portion for coupling a connecting member may be composed of one or more threads, the threads may have a cross-sectional shape of any one of triangle, a rectangle, an ellipse, and a circle, the threads have any one of a first class, a second class, and a third class, pitches of the threads may be a pitch of a thin thread or a common thread, and the threads may be left-hand threads or right-hand threads.

The first rebar and the second rebar are different in size.

A rebar connector having a pair of locking pieces according to an aspect of the present invention includes: a first rebar and a second rebar to be connected to each other with ends fitted to each other; a first connecting member having a center hole, receiving the first rebar into the center hole from a first side, having a first coupling hole at a second side, and having a threaded portion at a predetermined section on an outer side thereof; a locking piece-integrated second connecting member having a center hole therein, receiving the second rebar into the center hole through a first side, and having a groove at a second side; a first locking piece separately formed and having a base end inserted in the first coupling hole and a projection formed at a front end to correspond to the groove of the second connecting member; a second locking piece separately formed and coupled to the second coupling hole; and a locking socket locked at a predetermined position on the locking piece-integrated second connecting member, covering an outer side of the locking piece-integrated second connecting member, and having a female threaded portion on an inner side to be thread-fastened to the male threaded portion of the first connecting member, in which an integrated joint is formed by tightening the locking socket with the first locking pieces coupled to the first connecting member and the groove of the locking piece-integrated second locking member fitted to each other.

A method of connecting prefabricated rebar nets using the rebar connector having a pair of locking according to an other aspect of the present invention includes: coupling the first connecting member and the second connecting member to a first prefabricated rebar net and a second prefabricated rebar net; fitting the locking pieces on the prefabricated rebar nets to each other by lifting and placing the first prefabricated rebar net onto the second prefabricated rebar net; and correcting inclination of the first prefabricated rebar net by changing a position of the first connecting member or the second connecting member, thereby connecting the prefabricated rebar nets while correcting inclination of one of the prefabricated rebar nets.

A method of connecting prefabricated rebar nets using the rebar connector of according to another aspect of the present invention includes: coupling the second locking pieces and the second connecting members to a lower prefabricated rebar net that is fixed, coupling the first locking pieces and the first connecting members to an upper prefabricated rebar net, and lifting and placing down the upper prefabricated rebar net with the first locking pieces and the first connecting members, which are coupled to a end of one or more rebars selected in a same cross-section of the upper prefabricated rebar net, having different lengths; fitting the first locking pieces coupled to the ends of the rebars selected in cross-section of the upper prefabricated rebar net; securing verticality by correcting inclination of the upper prefabricated rebar net by changing the positions of the first connecting members coupled to the fitted first locking pieces; fixing positions of the first connecting members by tightening locking sockets after securing the verticality; fitting the locking pieces coupled to the other rebars by turning down the first connecting members at the ends of the other rebars while maintaining the verticality; fixing positions of the first connecting members turned down at the ends of the other rebar by tightening locking sockets, thereby connecting the prefabricated rebar nets while correcting inclination of one of the prefabricated rebar nets.

The rebars selected in the cross-section of the upper prefabricated rebar net may be any one of: reference rebars disposed at four corners and arranged in an X-shape or a +-shape when the cross-section of the upper prefabricated rebar net is a rectangle; reference rebars disposed at corners when the cross-section of the upper prefabricated rebar net is a polygon except for a rectangle; and reference rebars disposed at quadrantal positions when the cross-section of the upper prefabricated rebar net is a circle.

### Advantageous Effects

According to the present invention, it is possible to prevent initial slip of the first rebar and the second rebar in the joint using the first locking piece and the second locking piece by moving and rearranging locking nuts at both ends to the center in a method of tightening both ends of a coupler with the locking nuts.

Further, the first gap and the second gap defined by the first step and the front ends of the first connecting member and the second connecting member provide spaces for absorbing displacement generated by pulling force for removing initial slip of the first rebar and the second rebar.

Further, it is possible to integrate a joint with initial slip prevented against axial tensile force and compressive force.

Further, the first locking piece and the second locking piece have various shapes for axially fitting the first rebar and the second rebar to be connected, so it is possible to connect not only single rebars, but prefabricated rebar nets, and connect not only vertical rebars, but horizontal rebars.

Further, the first locking piece and the second locking piece can align axes of the first rebar and the second rebar and prevent initial slip of the first rebar and the second rebar in the joint.

Further, there is no need for the process of filling a coupler with a filler such as grout, so the work process is simple and the rigidity of the joint can be maintained against axial compressive force.

Further, it is possible to change the positions of the first connecting member and the second connecting member and fixing the positions of them by tightening a locking socket, so it is possible to correct various construction errors at site when connecting not only single rebars, but prefabricated rebar nets.

Further, it is possible to precisely connect prefabricated rebars by adjusting the inclination of one of the prefabricated rebar nets in front-rear, orthogonal, and left-right directions by changing the position of the first connecting member or the second connecting member.

Further, additional effects will be explained in the following description.

### DESCRIPTION OF DRAWINGS

FIG. 1 is a partial cross-sectional perspective view showing a first embodiment of the present invention.

FIG. 2 is a cross-sectional view showing the first embodiment of the present invention.

FIG. 3 is a cross-sectional view showing a first locking piece and a second locking piece according to the present invention.

FIG. 4 is a view showing a state when a first step at the base end of the second locking piece according to the present invention is locked to steps, which are bolts, for locking.

FIG. 5 is a cross-sectional view showing a first gap and a second gap.

FIG. 6 is a cross-sectional view showing a coupling order according to the first embodiment of the present invention.

FIG. 7 is a cross-sectional view showing a joint according to the first embodiment of the present invention.

FIG. 8 is a cross-sectional view showing a state when a gap distribution state in the joint is changed by applying torque to the locking socket and initial slip is absorbed.

FIG. 9 is a cross-sectional view showing a state when a first rebar and a rebar are axially fitted by a pair of locking pieces.

FIG. 10 is a cross-sectional view showing a state when the first locking piece is pressed by the first rebar.

FIG. 11 is an enlarged view of the portion I in FIG. 10.

FIG. 12 is an enlarged view of the portion II in FIG. 10 and a cross-sectional view showing a state when pressing is performed by the first rebar.

FIG. 13 is a cross-sectional view showing various embodiments of the front ends of a pair of locking pieces.

FIG. 14 is a cross-sectional view showing a state when the first locking piece and the second locking piece are forcibly fitted to the first connecting member and the second connecting member.

FIG. 15 is a cross-sectional view showing a state when prominences and depressions are formed on the inner side of the inlet of the second connecting member and a mark is formed.

FIG. 16 is an enlarged view of the portions III and IV in FIG. 15.

FIG. 17 is a conceptual view showing an embodiment including a deformed steel bar having a male threaded portion for coupling a connecting member.

FIG. 18 is a conceptual view showing a second embodiment.

FIG. 19 is a conceptual view showing a state when the inclination of a prefabricated rebar net is corrected by changing the position of the first connecting member.

FIG. 20 is a side view showing a state when an upper prefabricated rebar net is placed down after being lifted with the first locking pieces and the second locking pieces coupled to the ends of selected rebars and having different lengths.

FIG. 21 is a side view showing a state when the upper prefabricated rebar net is inclined to a side after the first locking pieces coupled to the ends of the selected rebars are fitted.

FIG. 22 is a side view showing a state when verticality of the upper prefabricated rebar net is secured by changing the positions of the first connecting members coupled to the fitted first locking pieces.

FIG. 23 is a side view showing a state when the positions of the first connecting members coupled to the ends of the selected rebars are fixed by tightening locking sockets after the verticality is secured.

FIG. 24 is a side view showing a state when the first locking pieces coupled to the ends of the other rebars are fitted by turning down the first locking pieces at the ends of the other rebars.

FIG. 25 is a side view showing a state when the position of the first connecting members coupled to the ends of the other rebars that have been fitted, by tightening locking sockets.

FIG. 26 is a flowchart showing steps for connecting prefabricated rebar nets.

### BEST MODE

Hereinafter, the present invention will be described in detail with reference to the accompanying drawings.

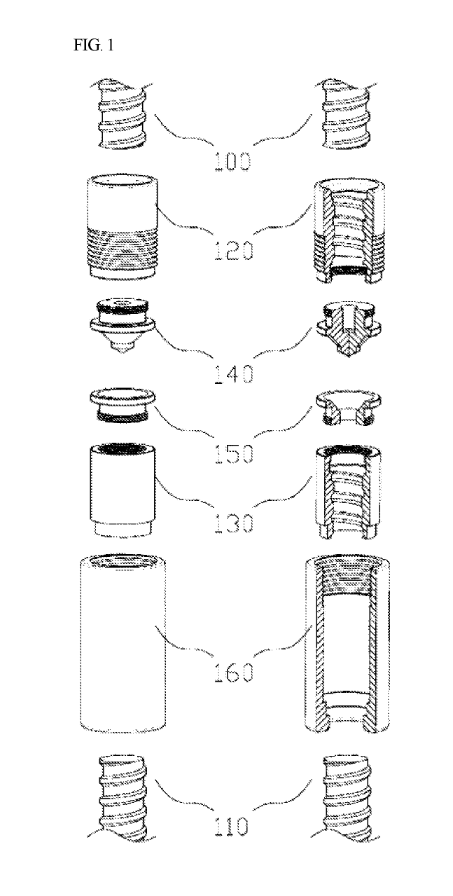

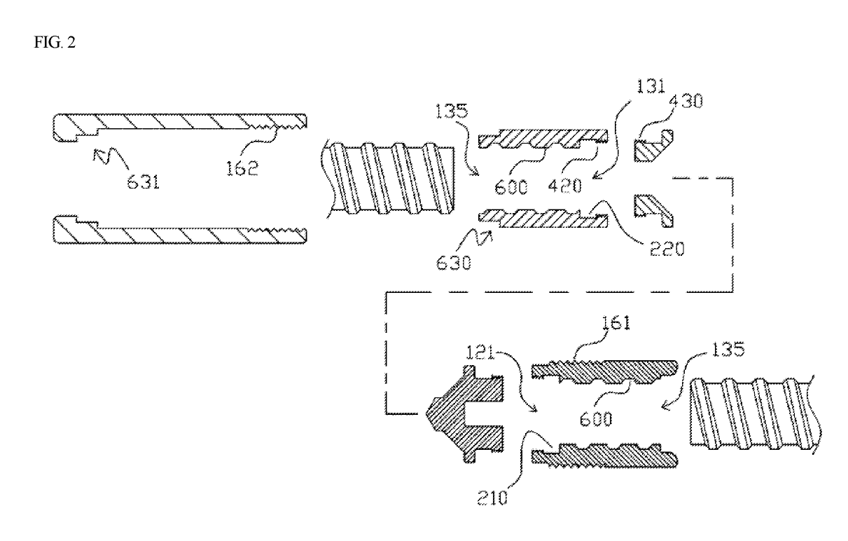

First, referring to FIGS. 1 and 2, a first embodiment includes a first rebar 100, a second rebar 110, a first connecting member 120, a second connecting member 130, a first locking piece 140, a second locking piece 150, and a locking socket 160.

The first rebar and the second rebar 100 and 110 to be connected at ends are prepared to be axially fitted to each other.

A member for connection is coupled to the first rebar 100 and the second rebar 110. First, the first connecting member 120 is coupled to the first rebar 100, and to this end, a center hole 135 is formed at or through the center or a predetermined position of the connecting member 120, an end of the first rebar 10 is inserted in the center hole 135 through a first side of the first connecting member 120, a first coupling hole 121 is formed at a second end, and a male threaded portion 161 is formed in a predetermined section on the outer side of the first connecting member 120.

Further, the second connecting member 130 is coupled to the second rebar 110, a center hole 135 is formed at or through the center or a predetermined position of the second connecting member 130, the second rebar 110 is inserted in the center hole 135 through a first side of the second connecting member 130, and a second coupling hole 131 is formed at a second side.

Further, the first locking piece 140 is separately formed to be inserted in the first coupling hole 121 and the second locking piece 150 is separately formed to be inserted in the second coupling hole 131.

In a method of fastening locking nuts to both ends of a coupler to connect the coupler to a steel bar in the related art, by moving the locking nuts at both ends to the center, initial slip of the first rebar 100 and the second rebar 110 from a joint 170 is prevented by the first locking piece 140 and the second locking piece 150.

Further, the locking socket 160 is locked at a predetermined position over the second connecting member 130, has a female threaded portion 162 in a predetermined section on the inner side, and is thread-fastened to the male threaded portion 161 of the first connecting member 120.

The locking socket 160 can be axially locked at a predetermined position on the second connecting member 130 and the first connecting member 120 is longitudinally fitted on the second connecting member 130 and thread-fastened in the first connecting member 120.

In this embodiment, the male threaded portion 161 and the female threaded portion 162 have left-hand threads, so the locking socket 160 is tightened in the left-hand thread direction.

Accordingly, the locking socket 160 is tightened with the first locking piece 140 coupled to the first connecting member 120 and the second locking piece 150 coupled to the second connecting member 130 fitted to each other, thereby achieving the joint 170.

The first locking piece 140 and the second locking piece 150, which have corresponding shapes and are fitted to each other, can be implemented in various ways as long as they can connect the first rebar 100 and the second rebar 110, thereby completing the joint 170.

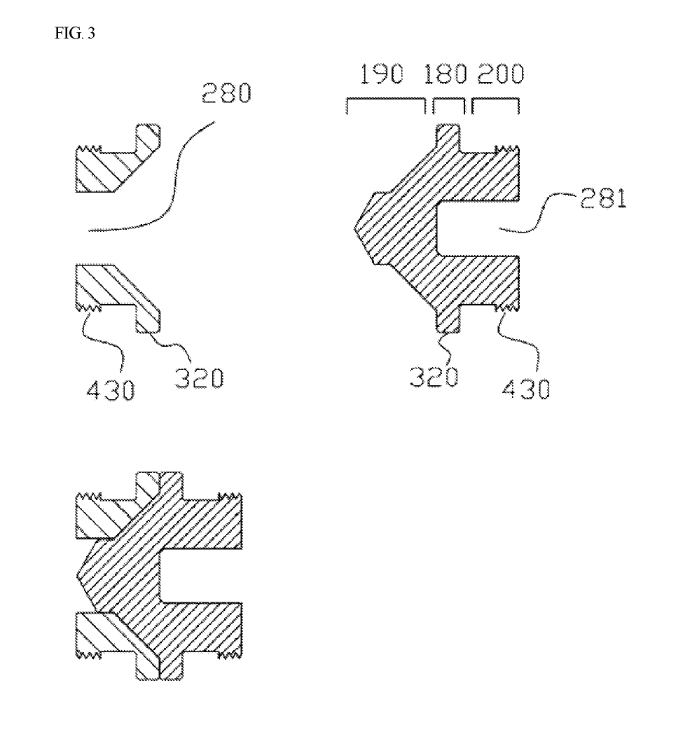

In this embodiment, referring to FIG. 3, the first locking piece 140 and the second locking piece 150 that are fitted to each other each have a body 180, a front end 190 formed at a first end of the body 180, and a base formed at a second end of the body 180, in which the base end 200 is inserted in the first coupling hole 121 or the second coupling hole 131, so the first locking piece 140 and the second locking piece 150 make a pair with the front ends 190 fitted to each other.

The first coupling hole 121 and the second coupling hole 131 respectively have a first space 210 and a second space 220 for absorbing displacement of the first connecting member 120 and the second connecting member 130 when the locking socket 160 is tightened.

The first space 210 and the second space 220 may be formed in various shapes, but in this embodiment, they communicate with the first coupling hole 121 and the second coupling hole 131, respectively, and receive the base ends 200 of the first locking piece 140 and the second locking piece 150.

The first space 210 and the second space 220 absorb displacement of the first connecting member 120 and the second connecting member 130 generated by tightening the locking socket 160 and, the locking socket 160 is tightened such that a first side is fitted on the second connecting member 130 and locked at a predetermined position on the second connecting member 130 and a second side is thread-fastened to the male threaded portion of the first connecting member 120; therefore, the first connecting member 120 and the second connecting member 130 pull each other and the first locking piece 140 and the second locking piece 150 cannot axially move after being fitted to each other. Accordingly, when the locking socket 160 is tightened, only the first connecting member 120 and the second connecting member 130 are moved. Therefore, the joint 170 is achieved with the first and second connecting members 120 and 130 pulled to each other by the locking socket 160.

The first space 210 and the second space 220 may be separately formed, but in this embodiment, the sizes of the first space 210 and the second space 220 depend on the coupling length of the first and second connecting members 120 and 130 and the first and second rebars 100 and 110, because the first space 210 and the second space 220 communicate with the center holes 135 of the first connecting member 120 and the second connecting member 130, the first rebar 100 and the second rebar 110 are inserted in the first space 210 and the second space 220 through the center hole 135 such that the front ends of the first rebar 100 and the second rebar 110 protrude.

That is, the sizes of the first space 210 and the second space 220 are decreased so that the first rebar 100 and the second rebar 110 can be moved forward after being inserted in the center holes 135 of the first connecting member 120 and the second connecting member 130. That is, the larger the coupling length of the first rebar 100 and the second rebar 110, the smaller the sizes of the first space 210 and the second space 220, and vice versa.

Referring to FIG. 13, a flat surfaces 230 perpendicular to the axial direction may be formed at the front ends 190 of the first locking piece 140 and the second locking piece 150 that are fitted to each other and the flat surfaces 230 perpendicular to the axial direction are fitted to each other in the joint 170 when the locking socket 160 is tightened.

Alternatively, a projection and a recession may be formed at the front ends 190 of the first locking piece 140 and the second locking piece 150 that are fitted to each other, so they are fitted to each other in the joint 170. The shapes of the front ends 190 of the first locking piece 140 and the second locking piece 150 may be exchanged.

The projections at the front end 190 of the first locking piece 140 and the second locking piece 150 are shaped to allow for axial alignment of the first rebar 100 and the second rebar 110. When the projections are formed in the shape of a cone 240, a vertical rebar can be guided along the inclined surface of the cone 240 by its weight.

Referring to FIG. 9, the locking pieces may have a multi-stepped inclined projection 250 having one or more of uniform sections and inclined sections longitudinally formed on the outer side and a recession corresponding to the multi-stepped inclined projection 250. Horizontal rebars are easily axially aligned through the uniform section and are prevented from moving downward in the fitted state, so vertical rebars and horizontal rebars can be easily connected.

When the multi-stepped inclined projection 260 is a multi-stepped rectangular projection 260 when the end is flat, and is a multi-stepped rounded projection 270 when the end is rounded, and they can be variously changed in shape to increase the effect of guiding in the axial direction of the joint 170.

The projection may be formed in any one of the shapes of a cone 240, a frustum-cone, a cone with a rounded top, a cylinder, a polypyramid, a frustum-polyprism, a polyprism with a rounded top, a polygonal cylinder, a sphere 245, an elliptical sphere, a frustum-spherical shape, and a frustum-elliptical sphere and may have a longitudinal cross-section that is any one of a triangle, a triangle with a rounded top, a rectangle, and a rectangle with rounded edges. Further, the end of the projection may be formed in any one of the shape of a cross, a combination of a cross and a circle, and a waved colgate shape.

When rebars to be connected have a larger diameter, the sizes of the first locking piece 140 and the second locking piece 150 need to be increased and the recession corresponding to the projection may be a through-hole 280 axially formed, so the material can be saved and the weight is reduced, whereby the manufacturing process can be simplified.

Alternatively, a groove 281 having a predetermined depth may be formed from the base end 200 of the first locking piece 140 or the second locking piece 150, whereby the material can be saved and the weight can be reduced.

First, when the first locking piece 140 or the second locking piece 150 and the first connecting member 120 and the second connecting member 130 are combined, the base ends 200 of the first locking piece 140 or the second locking piece 150 to be fitted to each other is fitted in the first coupling hole 121 and the second coupling hole 121, respectively, that is, the base ends of the first locking piece 140 or the second locking piece 150 are inserted in the first space 210 and the second space 220 of the first connecting member 120 and the second connecting member 130. In this state, the base ends 200 of the first locking piece 140 or the second locking piece 150 are loosely positioned in the first space 210 and the second space 220 after being inserted in the first space 210 and the second space 220.

That is, with the base ends 200 of the first locking piece 140 or the second locking piece 150 loosely inserted, the first connecting member 120 or the second connecting member 130 is combined with the first rebar 100 or the second rebar 110 and then tightened or the first rebar 100 or the second rebar 110 is rotated, so the first space 210 and the second space 220 are reduced, whereby the base ends 200 loosely inserted are gradually tightened.

Further, a second projection 320 is formed on the bodies 180 of the first locking piece 140 or the second locking piece 150 outward from the first space 210 and the second space 220 to limit the insertion depth of the first locking piece 140 or the second locking piece 150. Further, the second projections 320 are spaced from the front ends of the first connecting member 120 and the second connecting member 130 to define a first gap 400 and a second gap 410 that adjust the length of the joint 170 or remove initial slip.

The first gaps 400 and the second gap 410 defined by the second projections 320 and the front ends of the first connecting member 120 and the second connecting member 140 provide spaces for absorbing displacement due to pulling force for removing initial slip of the first rebar 100 and the second rebar 110.

The distances formed by the first gap 400 and the second gap 410 between the second projections 320 and the front ends of the first connecting member 120 and the second connecting member 130 depend on various factors such as the size of the first space 210 and the second space 220 of the first connecting member 120 and the second connecting member 130, the longitudinal and lateral sizes of the base ends 190 and 200 and the front ends of the first locking pieces 140 and the second locking pieces 150, the lateral size of the first projections 300 at the base ends 200, the positional relationship between the second projections 320 on the bodies 180, and the lateral size of the second projections 320.

The first locking piece 140 and the second locking piece 150 are supposed to be locked to the inner sides of the first space 210 and the second space 220, so a step for locking the first projections 300 at the base ends 200 of the first locking piece 140 and the second locking piece 150 is formed inside the first space 210 and the second space 220.

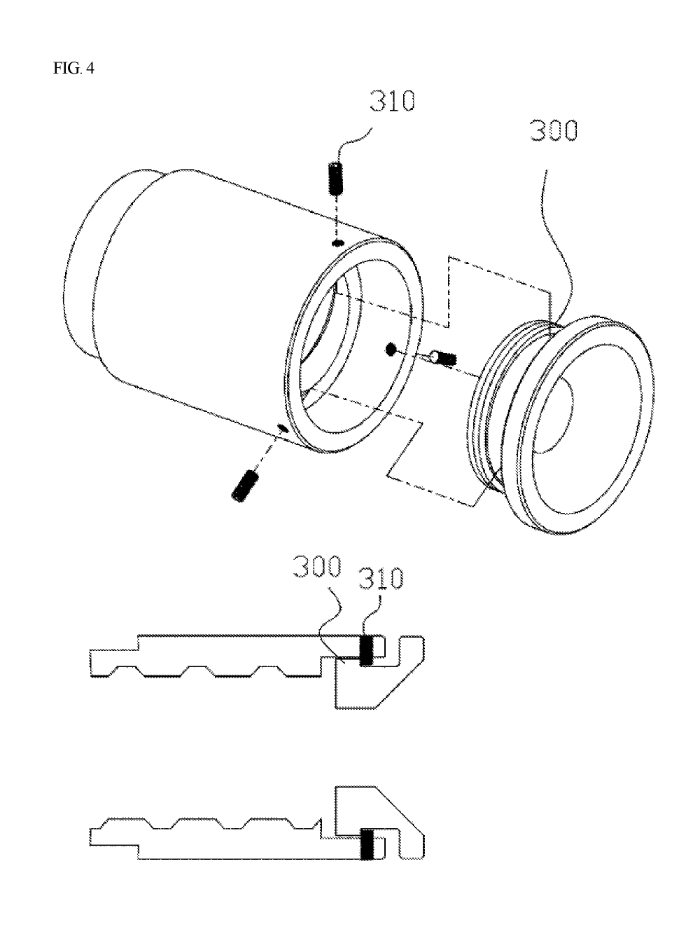

Referring to FIG. 4, the steps may be formed in various ways, but in this embodiment, they are limited to one or more bolts 310.

The bolts 310 may also be implemented in various ways, but in this embodiment, the bolts 310 are axially aligned toward the center of the locking pieces and may be set screws having a diameter of around 3mm or studs. Further, three or more bolts 310 may be provided.

The bolts 310 are tightened in the first connecting member 120 or the second connecting member 130 and the protruding ends of the bolts are the first projections 300 of the first locking pieces 140 and the second locking pieces 150.

The loosely tightened base ends 200 of the first locking piece 140 and the second locking piece 150 can be compressed and fixed at predetermined positions by the front ends of the first rebar 100 and the second rebar 110. That is, the first space 210 and the second space 220 communicate with the center holes 135 of the first connecting member 120 and the second connecting member 130, so the first locking piece 140 and the second locking piece 150 can be compressed by the front ends of the first rebar 100 and the second rebar 110 inserted in the center holes 135, in which the insertion positions of the first rebar 100 and the second rebar 110 are determined by the length of the coupling section with the first connecting member 120.

When the base ends 200 of the first locking piece 140 and the second locking piece 150 are not fully inserted, the first locking piece 140 and the second locking piece 150 are fitted to each other, facing the first rebar 100 and the second rebar 110 and then the locking socket 160 is tightened such that the locking pieces are compressed. Further, torque that is applied to tighten the locking socket 160 changes the circumferential position of the locking socket 160 and moves the first connecting member 120 and the second connecting member to each other, and the displacement of the base ends 200 of the first locking piece 140 and the second locking piece 150 fixed to each other is obtained by the first space 210 and the second space 220 of the first connecting member 120 and the second connecting member 130.

That is, the first connecting member 120 and the second connecting member 130 pull each other, so the base ends 200 of the first locking piece 140 and the second locking piece 150 positioned at the front ends of the first rebar 100 and the second rebar 110 are moved toward the rebars and close to each other. Accordingly, the base ends 200 of the first locking piece 140 and the second locking piece 150 are further inserted into the first space 210 and the second space 220 and the displacement of the first locking piece 140 and the second locking piece 150 is absorbed by the first gap 400 and the second gap 410.

The absorbed displacement results from the pulling force of the first connecting member 120 and the second connecting member 130 which is applied to the locking socket 160 and the joint 170 is achieved with the first locking piece 140 and the second locking piece 150 pressed by the pulling force. Accordingly, it is possible to achieve the joint 170 in a structure without initial slip even if the base ends 200 of the first locking piece 140 and the second locking piece 150 are not fully pressed.

However, the base ends 200 of the first locking piece 140 and the second locking piece 150 may be fitted in the first space 210 and the second space 220 and pressed by the front ends of the first rebar 100 and the second rebar 110 by the front ends of the firs rebar 100 and the second rebar fitted in the center holes 135 of the first connecting member 120 and the second connecting member 130.

That is, the loosely tightened base ends 200 of the first locking piece 140 and the second locking piece 150 are pressed by the front ends of the first rebar 100 and the second rebar 110, so they can be coupled to the first rebar 100 and the second rebar 110.

Referring to FIG. 8, when the first locking pieces 140 and the second locking pieces 150 are pressed to be fixed and then the locking socket 160 is tightened, torque for changing the circumferential position of the locking socket 160 with the locking pieces fitted to each other moves the first connecting member 120 and the second connecting member 130 toward each other and the displacement of the first connecting member 120 and the second connecting member 130 is absorbed by the first gap 400 and the second gap 410, thereby achieving the joint 170 with the initial slip absorbed by the first gap 400 and the second gap 410, so the initial slip of the joint 170 is removed.

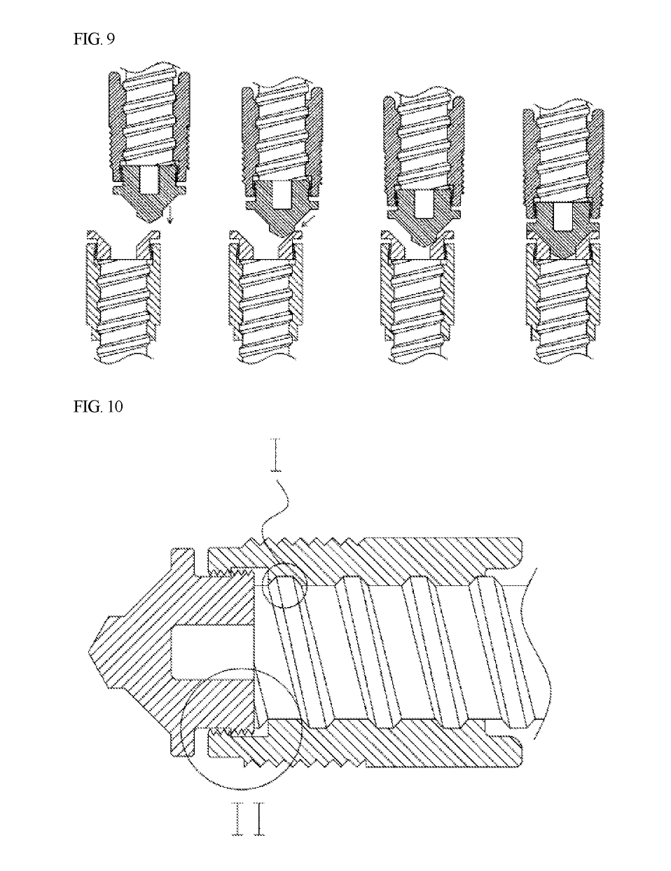

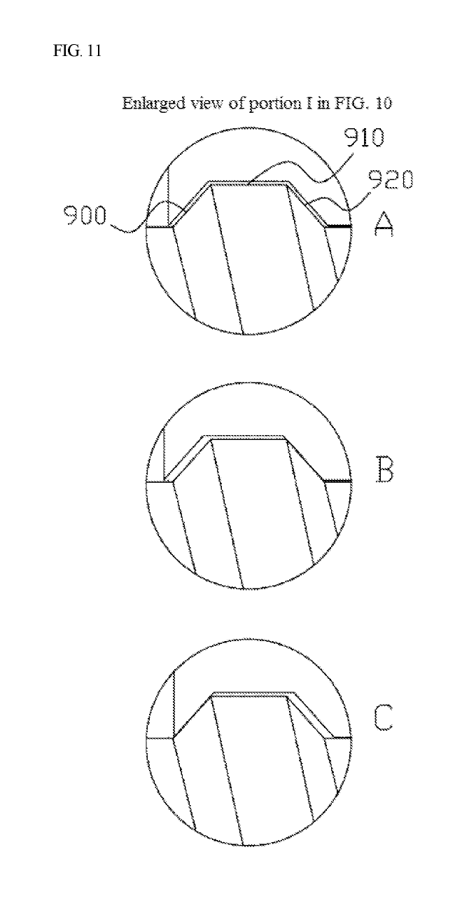

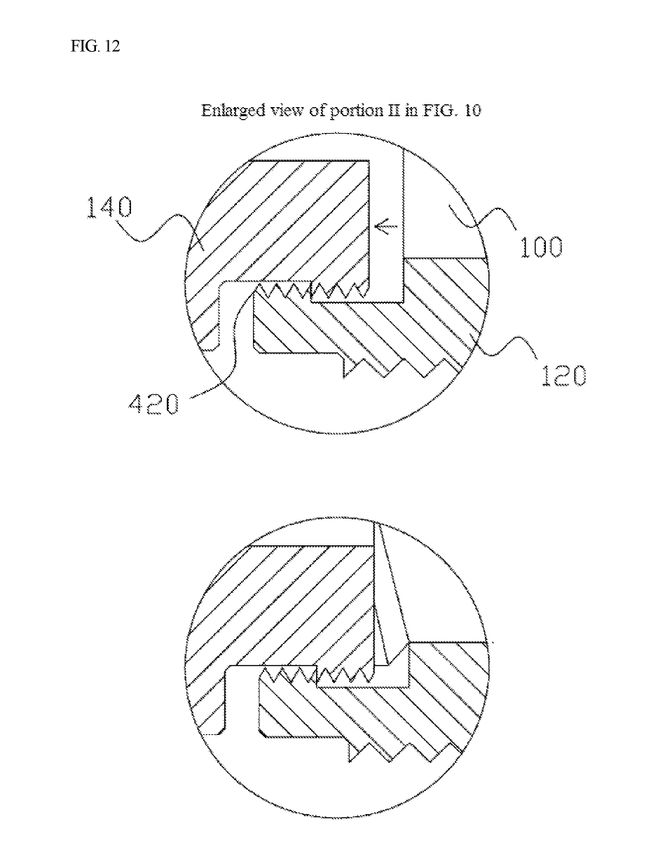

A process of forming the joint 170 is described with reference to FIGS. 10 and 11 under the assumption that there is a gap between the inner side of the first connecting member 120 and the outer side of a threaded rebar. When a threaded rebar is provided and the threads on the threaded rebar each have a trapezoidal cross-section with a first surface 900 that is an inclined surface protruding outward, a second surface 910 that is a horizontal surface, and a third surface 920 that is an inclined surface.

The threaded rebar has a sufficient tolerance for thread-fastening due to the shape of threads, bending at an end, and burrs that are generated in cutting. For example, in the combination of the first connecting member 120 and the first rebar 100, when the first rebar 100 is thread-fastened to the first connecting member 120, the first surface 900, the second surface 910, and the third surface 920 are spaced from a groove of the female threaded portion 600 for thread-fastening the threaded rebar in the gap distribution state indicated by ‘A’.

First, when only the first connecting member 120 is thread-fastened to the first rebar 100, the gap distribution state A is shown.

Next, the first locking piece 140 is placed in the first space 210 of the first connecting member 120, and when the first locking piece 140 is a loose state, the gap distribution state is maintained. In this state, initial displacement cannot be generated against both of axial compressive and tensional force.

Next, when the position of the first rebar 100 or the first connecting member 120 is changed and the first locking piece 140 is pressed in the first space 210, the base end 200 of the first locking piece 140 is pressed toward the first rebar 100 and the first rebar 100 is correspondingly moved forward. Accordingly, the third surface 920 of the first rebar 100 is brought in contact with the inner side of the first connecting member 120, and in this state, the first rebar 100, the first connecting member 120, and the first locking piece 140 are integrated, thereby making the gap distribution state indicated by ‘B’.

Next, when the locking socket 160 is tightened with the first locking piece 140 and the second locking piece 150 fitted to each other, the first connecting member 120 and the second connecting member 130 are pulled toward the contact surface of the first locking piece and the second locking piece, so all of the threads go into the gap distribution state B by the pulling force applied to the first connecting member 120 and the second connecting member 130.

Next, the first locking piece and the second locking piece react against the pulling force of the first connecting member 120 and the second connecting member 130, so pushing force is applied from the contact surface to the first locking piece and the second locking piece, and accordingly, the gap distribution state B is generated by pulling force applied to all of the threads of the first connecting member 120 and the second connecting member 130.

Even though axial tensile force is applied with the gap distribution state B uniformly generated, the third surface 920 and the inner sides of the first connecting member 120 and the third connecting member 130 are still in contact with each other in the gap distribution state B, so initial slip is not generated.

That is, when axial tensile force is applied to rebars with ends facing each other, the gap distribution state B is generated, and in contrast, even if compressive force is applied, the gap distribution state B is maintained, and not changed into the gap distribution state C. Accordingly, initial slip cannot be generated in the gap distribution state B when axial tensile force is applied, and in order to change into the gap distribution state C from the gap distribution state B when axial compressive force is applied due to reaction, the third surface 920 and the inner side of the first connecting member 120 should be separated, but the first locking piece 140 and the second locking piece 150 are still fitted to each other and the base ends 200 of the locking pieces are pressed again by the rebars, so it cannot be changed into the gap distribution state A or C. Therefore, initial slip cannot be generated in the gap distribution state B even though axial compressive force is applied.

Therefore, it is possible to achieve a joint with initial slip prevented against both of axial tensile force and compressive force.

As a result, the threads on the threaded rebar have a shape that is difficult to be precisely fastened, but the threads on the threaded rebar can be fastened to the first connecting member in the gap distributions state B by the joint 170, so the threaded rebar can be precisely fastened by the female threaded portion 162 of the locking socket 160 and the male threaded portion 161 of the first connecting member 170, in which the female and male threaded portions have thin threads of a predetermined size.

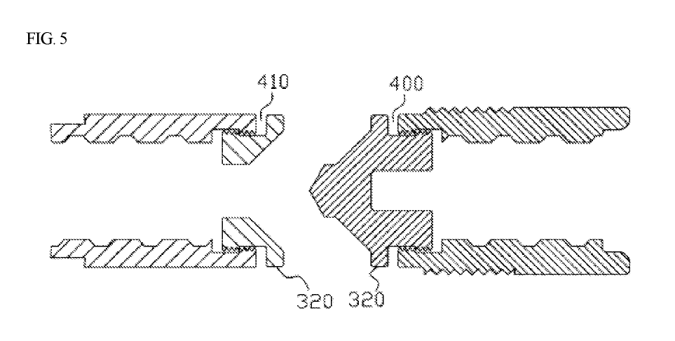

The first locking piece 140 and the second locking piece 150 can be coupled to the first connecting member 120 and the second connecting member 130 in various ways, but for example, referring to FIG. 5, first female threads 420 are formed on the inner sides of the inlets 440 of the first space 210 and the second space 220 and a first male threads 430 are formed at a predetermined section on the outer sides of the base ends 200 of the first locking piece 140 and the second locking piece 150 such that the first male threads 430 can be thread-fastened in the inlets 440, respectively. The threads may be thin threads to correspond to the thickness of the inlets 440 of the first space 210 and the second space 220.

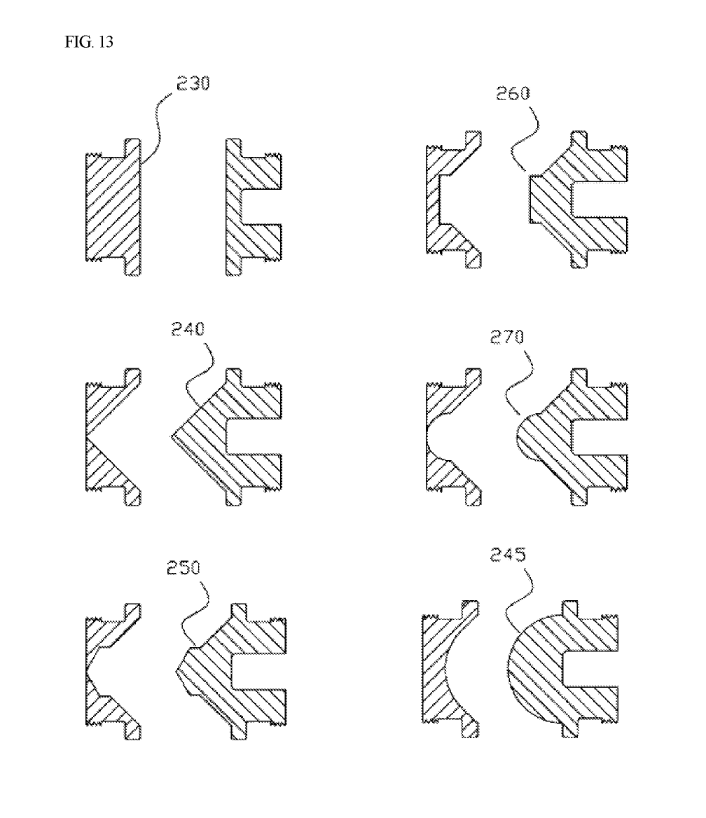

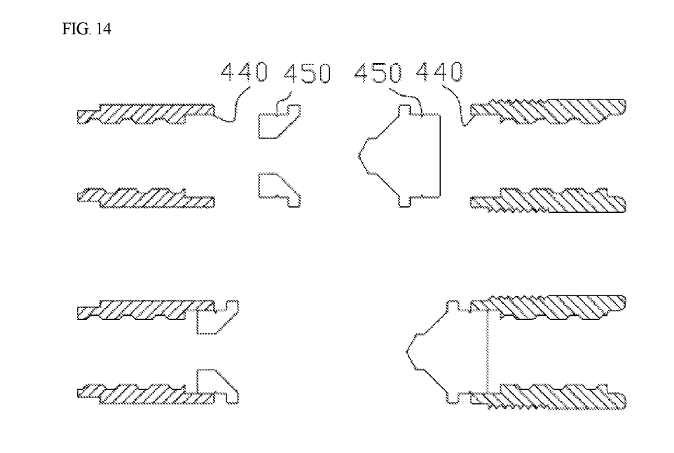

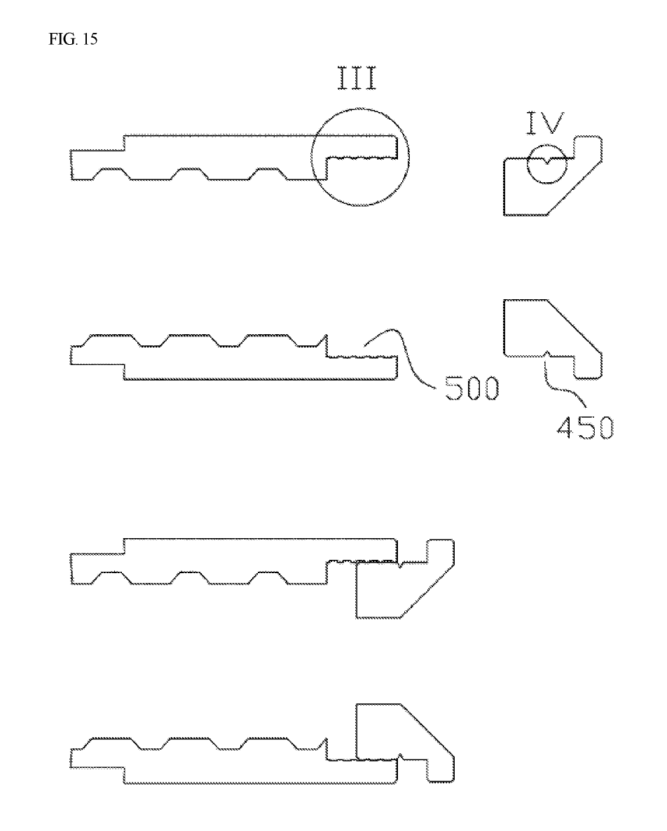

Thereafter, referring to FIGS. 10 and 12, the base ends 200 of the first locking piece 140 and the second locking piece 150 inserted in the inlets 440 are pressed to the front ends of the first rebar 100 and the second rebar 110 and are fitted between the first female threads 420 on the inner sides of the inlets 440 and the front ends of the first rebar 100 and the second rebar 110, whereby the first locking piece 140 and the second locking piece 150 is compressed.

That is, there is no need a specific configuration for compressing the base ends 200 of the first locking piece 140 and the second locking piece 150.

As another example of coupling the first locking piece 140 and the second locking piece 150 to the first connecting member 120 and the second connecting member 130, the inner sides of the inlets 440 of the first space 210 and the second space 220 and predetermined sections on the outer sides of the base ends 200 of the first locking piece 140 and the second locking piece 150 may be formed to have a predetermined tolerance so that the base ends 200 of the first locking piece 140 and the second locking piece 150 can be forcibly fitted in the inlets 440.

A mark 450 showing the primary insertion position in forcible fitting is formed at predetermined positions on the base ends 200 of the first locking piece 140 and the second locking piece 150 so that work efficiency can be increased and a worker can easily see the degree of insertion of the first locking piece 140 and the second locking piece 150.

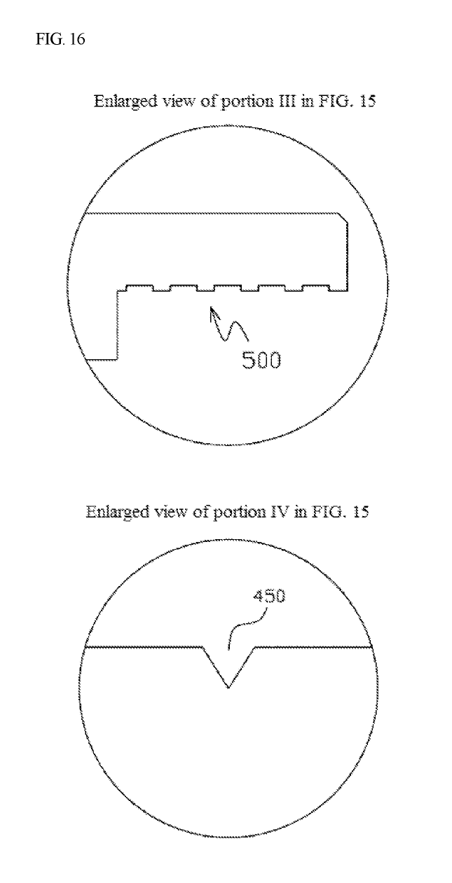

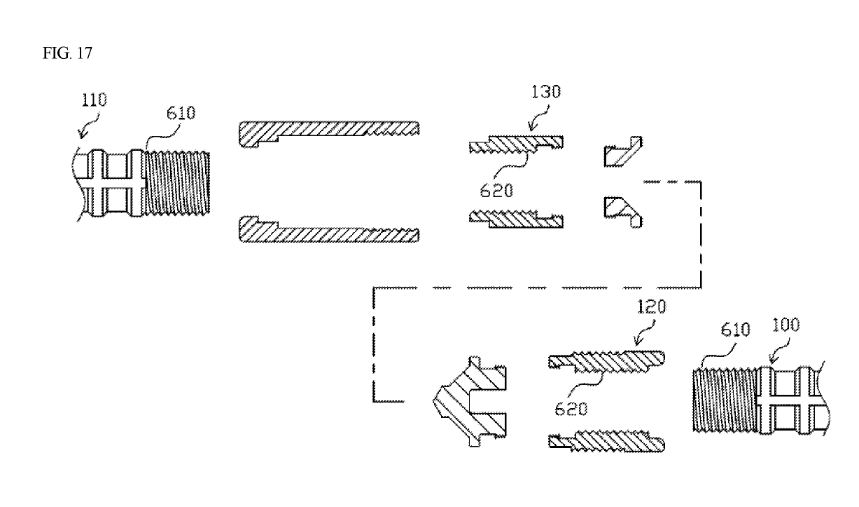

Further, referring to FIGS. 15 and 16, prominences and depressions may be formed on the inner side 440 of the first space 210 or the second space 220 for easy insertion and separation in forcible fitting.

The first locking piece 140 and the second locking piece 150 substantially correspond to locking nuts that are fastened to both ends of couplers in the related art, but they are not exposed at both ends of the couplers, but inserted to the center inside the joint 170, so it is possible to complete locking with nuts for removing initial slip at a time only by tightening the locking socket 160.

That is, according to the related art, a locking nut is fastened to both ends of a coupler, so it is required to perform tightening three times for one coupling by tightening the locking nuts and the coupler, but according to the present invention, it is possible to tighten rebars, compress two locking pieces, and remove initial slip by tightening the locking socket 160 only one time, so it is possible to easily connect rebars and reduce the construction period.

Further, the first locking piece 140 and the second locking piece 150 may have various shapes at the front ends 190 for axial alignment to the first rebar 100 and the second rebar 110 to be connected, so they are suitable for connection of not only single rebars, but prefabricated rebar nets, and are also suitable for connection of not only vertical rebars, but horizontal rebars.

Further, the joint 170 with initial slip removed can be applied to both an tensile rebar and a compressive rebar, so the present invention can be applied to connection of both of single rebars and prefabricated rebar nets that are used for pillars, inner walls, outer walls, beams, slabs, and basement structures where both tensile rebars and compressive rebars are used.

Further, there is no need for the process of filling a coupler with a filler such as grout, so the work process is simple and the rigidity of the joint 170 can be maintained against axial compressive force.

When the first rebar 100 and the second rebar 110 are threaded rebars, female threaded portions for fastening the threaded rebars are formed in the center holes 135 of the first connecting member 120 and the second connecting member 130.

According to the present invention, one member is coupled to the end of a threaded rebar, unlike the couplers in the related art, so it is not required to provide an excessive tolerance of the pitch over half of the pitch in order to insert the ends of threaded rebars in both ends of a coupler, and the tolerance of the pitch can be made close to the level of a first class bolt, so a simple and strong joint can be achieved.

That is, the female threaded portion 600 for fastening a rebar in the center holes 135 of the first connecting member 120 and the second connecting member 130 may be formed to have a pitch that is enough to insert only the end of a threaded rebar, so the thread tolerance can be reduced. Further, the number of threads is reduced, so the length of the first connecting member 120 and the second connecting member 130 can be reduced in comparison to the couplers of the related art, and accordingly, reliability of the joint 170 can be increased, as compared with connection in the related art.

When the first rebar 100 and the second rebar 110 are deformed steel bars, the male threaded portion 610 for coupling a connecting member should be formed at the ends of the first rebar 100 and the second rebar 110, in which the male threaded portion 610 for coupling a connecting member may be formed by any one of forming set threads through form rolling after swaging at the end of the deformed steel bar, forming cut threads through cutting, or attaching a threaded connection member that is separately formed.

The threaded connection member may be attached by welding including friction welding or stud welding.

Referring to FIG. 17, a female threaded portion 620 to be thread-fastened to the male threaded portion 610 formed at the ends of the first rebar 100 and the second rebar 110 that are deformed steel bars to couple a connecting member is formed in the holes of the first connecting member 120 and the second connecting member 130, whereby the first rebar 120 and the second rebar 110 are coupled to the first connecting member 120 and the second connecting member 130, respectively.

Referring to FIG. 2, the locking socket 160 is locked to the second connecting member 130 when being tightened, the first locking step 630 having one or more steps is formed at a predetermined position on the second connecting member 130 where the locking socket 160 is locked, and the second locking step 631 having one or more steps to be locked to the first locking step 630 is formed on the inner side of the locking socket 160, in which the steps having one or more steps may be formed with an acute angle, a right angle, or an obtuse angle, or may be curved with a predetermined curvature.

Further, the steps having one or more steps may be formed with an acute angle, a right angle, or an obtuse angle, or may be curved with a predetermined curvature to efficiently distribute axial stress.

The projections of the locking pieces can be changed in various shapes for axially guiding the locking pieces, so when the projections are formed in the shape of the sphere 245 or an elliptical sphere and the first locking step 630 and the second locking step 631 are curved, it is possible to sequentially connect curved deformed steel bars or curved threaded steel bars for constructing structures such as a lattice girder in construction of a tunnel by finely adjusting the contact surface and contact angle of the locking pieces for connecting the curved deformed steel bars or the curved threaded steel bars that are arranged with a predetermined curvature.

A portion for preventing slide and allowing for easily holding with a hand may be formed on the outer sides of the first connecting member 120, the second connecting member 130, and the locking socket 160.

The portion for preventing slide may be formed by forming a spline on the outer sides, knurling the outer side, forming the cross-section in a circle, forming the cross-section in a polygon, or forming a holding surface at one or more positions facing each other in order to easily hold tools by hand and smoothly tighten the locking socket 160.

The male threaded portion 161, the female threaded portion 162, the first female threads 420, the male threads 430, the male threaded portion 610 for coupling a connecting member, and the female threaded portion 620 for coupling a connecting member may be composed of one or more threads, the threads may have a cross-sectional shape of any one of triangle, a rectangle, an ellipse, and a circle, the threads have any one of a first class, a second class, and a third class, the pitches of the threads are that of a thin thread or a common thread, and the threads may be left-hand threads or right-hand threads.

When the first rebar 100 and the second rebar 110 are different in size, the center holes 135 of the first connecting member 120 and the second connecting member 130 may have different sizes corresponding to the first rebar 100 and the second rebar 110, whereby rebars having different sizes can be connected.

The locking socket 160 may be coupled to the first connecting member 120 and locked at a predetermined position on the first connecting member 120 and then the male threaded portion 161 is fastened to the outer side of the second connecting member 130, whereby the locking socket 160 is thread-fastened, covering the first connecting member 120, thereby making the joint 170.

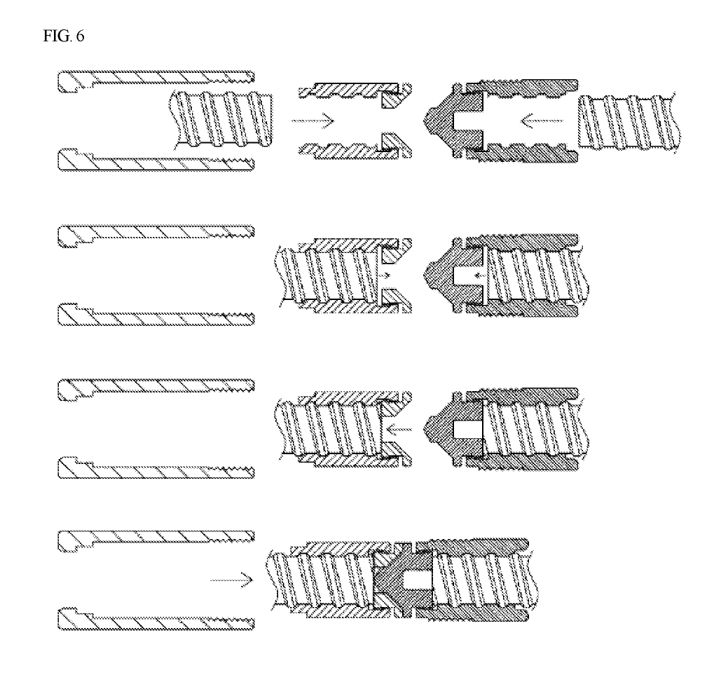

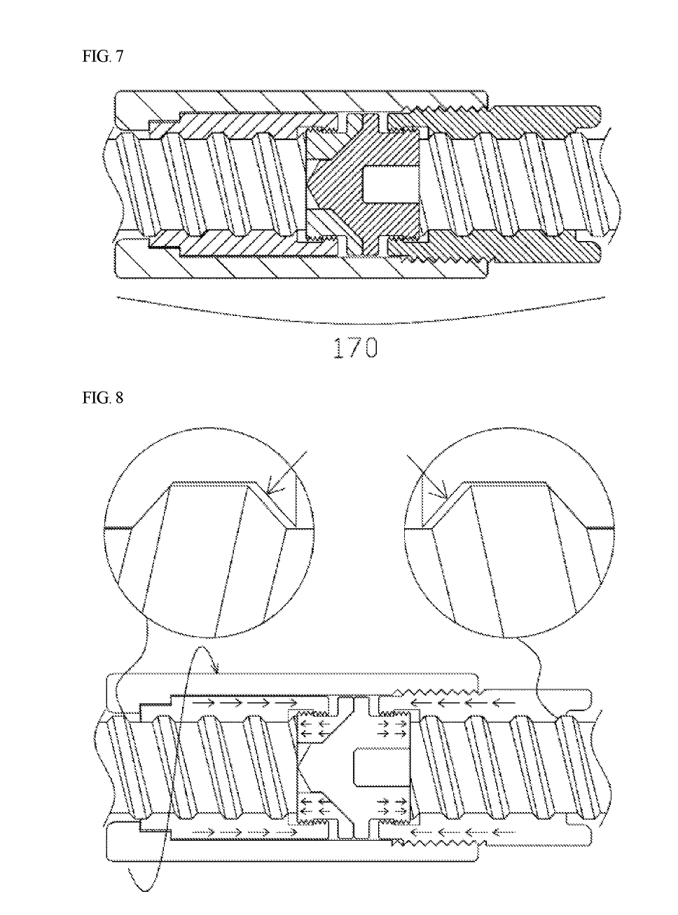

According to this embodiment, referring to FIGS. 6 and 7, the joint 170 is achieved by inserting the first locking piece 140 and the second locking piece 150 into the first coupling hole 121 and the second coupling hole 131 of the first connecting member 120 and the second connecting member 130;

inserting the first rebar 100 and the second rebar 110 into the holes 153 of the first connecting member 120 and the second connecting member 130;

pressing the base ends of the first locking piece 140 and the second locking piece 150 to the front ends of the first rebar 100 and the second rebar 110;

fitting the first locking piece 140 and the second locking piece 150 to each other;

integrating the joint 170 by tightening the locking socket 160; and

absorbing displacement of the first connecting member 120 and the second connecting member 130 with the first gap 400 and the second gap 410 by applying pulling force to the first connecting member 120 and the second connecting member 130 by applying torque to the locking socket 160.

The first connecting member 120, the second connecting member 130, the first locking piece 140, the second locking piece 150, and the locking socket 160 may be made of metal or other materials, may be manufactured by molding, cutting, or drawing, including forging, that is, cold forging and hot forging, and may undergo thermal treatment such as quenching-tempering to increase the strength, if necessary.

Next, a first rebar 100, a second rebar 110, a first connecting member 120, a first locking piece 140, a locking piece-integrated second connecting member 700, and a locking socket 160 are included in a second embodiment.

That is, the description of the first embodiment is referred to for the other components and the locking piece-integrated second connecting member 700 is described in this embodiment.

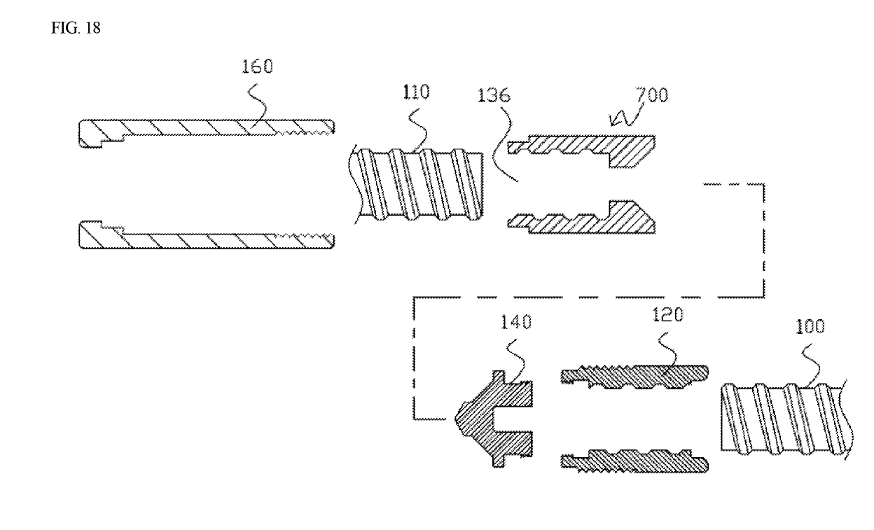

That is, referring to FIG. 18, the locking piece-integrated second connecting member 700 has a center hole 136 for coupling a rebar, the second rebar 110 is coupled to a first end of the locking piece-integrated second connecting member 700, a groove is formed at a second end and the first locking piece 140 having a projection corresponding to the groove of the locking piece-integrated second connecting member 700 is inserted in the groove, thereby forming a joint.

That is, the locking piece-integrated second connecting member 700 does not need the second locking piece 150 of the first embodiment.

Accordingly, since there is no need for the second locking piece 150, the joint has a simple configuration in comparison to the first embodiment.

Accordingly, the locking socket 160 is tightened with the first locking piece 140 coupled to the first connecting member 120 and the locking piece-integrated second connecting member 700 fitted to each other, thereby achieving the joint.

In contrast, the second locking piece 150 and the second connecting member 130 may be separately formed and the first locking piece 140 may be integrated with the first connecting member 120 to form a locking piece-integrated first locking member.

A method of connecting prefabricated rebar nets while correcting construction errors using the rebar connector having a pair of locking pieces is described hereafter.

In a method of arranging prefabricated rebar nets for pillars, inner walls, outer walls, beams, slabs, and basement structures to construct a rebar concrete structure, the prefabricated rebar nets to be assembled by a jig are composed of longitudinal bars and tie bars for a pillar, longitudinal bars and stirrup bars for a beam, and other longitudinal bars or stirrup bars or longitudinal bars and coupler rebars and are formed by pre-assembling reinforced structures for example through welding in a factory or at the site, and then the prefabricated rebar nets are lifted and connected for the basic structure, in which construction errors are caused by various factors.

The tolerances are necessary due to the characteristics when connecting prefabricated rebar nets at the site. For example, a jig provides a precise tolerance, but it may be deformed by as bending or torsion due to the weight of the prefabricated rebar nets while they are delivered to the site. In this case, when the prefabricated rebar net at the base is moved while concrete is poured, longitudinal construction errors are caused at the ends of another prefabricated rebar net that is lifted and placed the prefabricated rebar net at the base, so the ends of the prefabricated rebar net placed latter are not placed in the same cross-section and discontinuously arranged, thus various construction errors are caused in this way.

It is difficult to immediately correct the construction errors using the existing coupler at the site, so using the locking socket 160 that freely corrects coupling positions by changing the positions of connecting members with a pair of locking pieces proposed by the present invention makes it possible to freely correct connection between single rebars and prefabricated rebar nets, whereby it is possible to absorb construction errors.

That is, the method includes: coupling the first connecting members 120 and the second connecting members 130 to a first prefabricated rebar net 800 and a second prefabricated rebar net 810; fitting the locking pieces on the prefabricated rebar nets to each other by lifting and placing the first prefabricated rebar net 800 onto the second prefabricated rebar net 810; and correcting the inclination of the first prefabricated rebar net 800 by changing the position of the first connecting member 120 or the second connecting member 130, in which the prefabricated rebar nets 800 and 810 are connected by correcting the inclination of the first prefabricated rebar net 800.

The changing of position is to turn one of members that are thread-fastened to each other in a predetermined direction to a predetermined position on the threads.

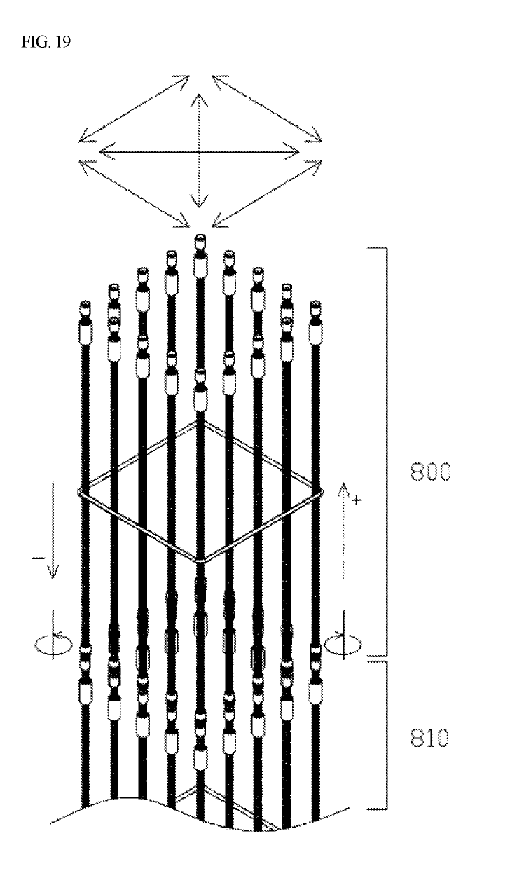

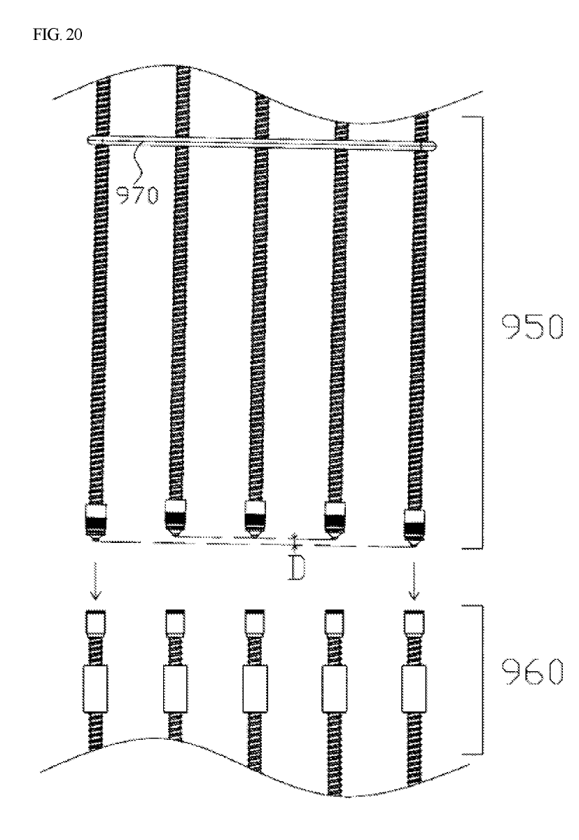

Accordingly, referring to FIG. 19, by changing the positions of the first connecting members 120 or the second connecting members 130, the inclination of the first prefabricated rebar net can be adjusted in the front-rear, orthogonal, and left-right directions, whereby it is possible to precisely connect the prefabricated rebar nets.

That is, it is possible to connect single rebars or prefabricated rebar nets by correcting the verticality when connecting the longitudinal bars for a pillar and by correcting the horizontality when connecting the longitudinal bars for a beam.

A method of securing verticality of an upper prefabricated rebar net 950 by absorbing a construction tolerance when connecting prefabricated rebar nets to make the base of a pillar is described hereafter. That is, the angle between the ground and the upper prefabricated rebar net 950 can be freely adjusted, but a method of securing verticality is described in this embodiment.

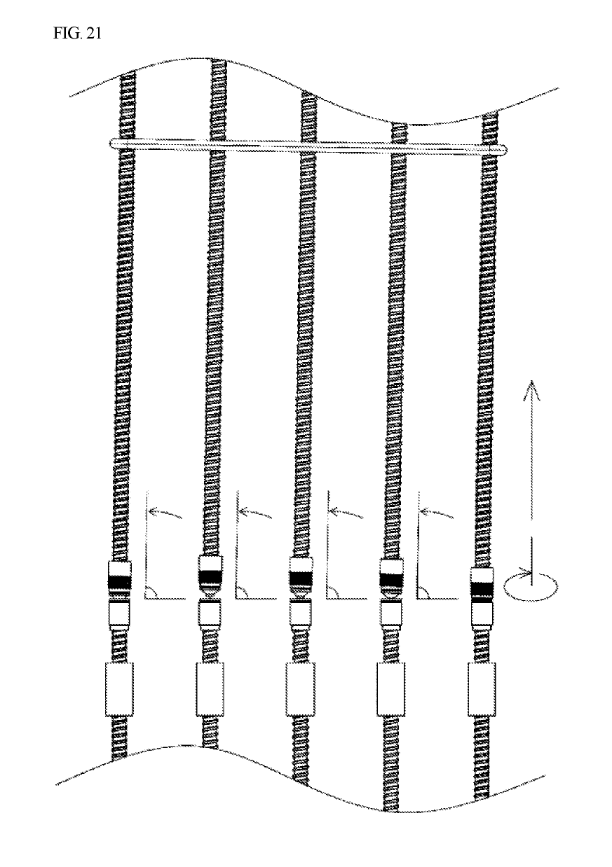

First, referring to FIG. 20, a process of connecting prefabricated rebar nets is started with a step (S1) of coupling the second connecting members 130 combined with the second locking pieces 150 to a lower prefabricated rebar net 960 that is fixed, coupling the first connecting members 120 combined with the first locking pieces 140 to the upper prefabricated rebar net 950, and then lifting and then moving down the upper prefabricated rebar net 950.

The second connecting members 130 combined with the second locking pieces 150 are movably coupled to the lower prefabricated rebar net 960 such that the locking sockets 160 can be turned upward.

In order to correct the inclination of the upper prefabricated rebar net 950, the first connecting member 120 coupled to an end of a predetermined rebar to be fitted first may be adjusted to protrude further than the first connecting members 120 coupled to ends of the other rebars to be fitted later so that the front end can be fitted first after lifting, whereby a position difference D is generated before lifting.

Next, referring to FIG. 21, the first locking pieces 140 coupled to one or a plurality of rebars selected in the same cross-section are fitted first (S2).

The first locking piece 140 and the second locking piece 150 are fitted to each other by fitting the front ends 190 facing each other to each other, in which fitting by projections and fitting by a axial fitting member are included.

That is, the locking pieces at predetermined rebars are fitted first to efficiently adjust the angle of the upper prefabricated rebar net 950.

For example, when the longitudinal bars in the same cross-section make a polygon in a prefabricated rebar net, it is advantageous to fit the first locking pieces 140 at the ends of the longitudinal bars at corners in the same cross-section in terms of changing the angle of the upper prefabricated rebar net 950.

That is, when longitudinal bars for a pillar make a rectangle in the same cross-section, it is advantageous to fit the four longitudinal bars at the four corners and then change the angle of the upper prefabricated rebar net 950 around the four longitudinal bars, that is, with respect to the four longitudinal bars.

Accordingly, when the upper prefabricated rebar net 950 has a rectangular cross-section, the rebars at four corners in the same cross-section are selected as reference rebars, in which the reference rebars may be arranged in an X-shape or a +-shape.

When the upper prefabricated rebar net 950 has a polygonal cross-section rather than a rectangle, the rebars at the corners in the same cross-section are selected as reference rebars.

When the upper prefabricated rebar net 950 has a circular cross-section rather than a rectangle, the rebars the quadrantal points in the same cross-section are selected as reference rebars.

The upper prefabricated rebar net 950 is placed down by its weight and the fitted, so the lengths of the ends depend on the entire lengths of the first locking pieces 140 and the first connecting members 120 coupled to each other, but the longitudinal bars are surrounded by a tie bar 970, so they are difficult to vertically move, and accordingly, the prefabricated rebar net 950 is placed at an angle in any direction.

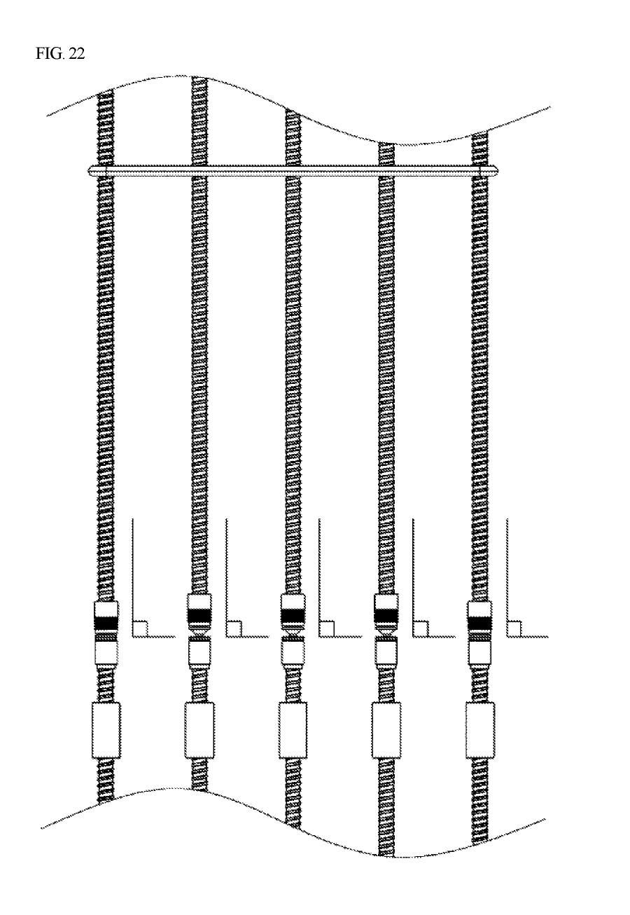

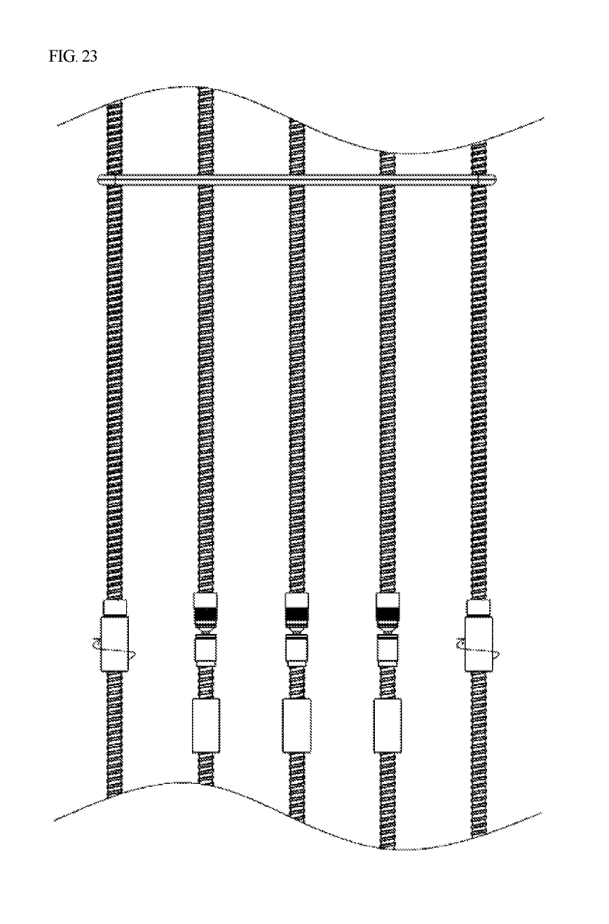

Next, referring to FIG. 22, a step (S3) of securing verticality by inclining the upper prefabricated rebar net 950 in the front-rear, orthogonal, and left-right directions is performed by changing the positions of the first connecting members 120 with the first locking pieces 140 fitted.

The upper prefabricated rebar net 950 is placed down and the weight of the prefabricated rebar net 950 is distributed proportionally to the contact surfaces of the locking pieces, so when torque corresponding to this state is applied and changes the position of a first connecting member 120, the front end 190 of the first locking piece 140 is supported upward and the change of position of the first connecting member 120 makes first upward displacement of the longitudinal bar thereon.

That is, when the first connecting members 120 and the upper prefabricated rebar net 950 are thread-fastened in the right-hand thread manner and a first connecting member 120 is turned right, the first locking piece 140 is supposed to move down, but it cannot move down because it is supported on the front, and as a result, the rebar on the first locking piece 140 is moved upward.

The predetermined rebar moved upward is included in the upper prefabricated rebar net 950, so when the upper prefabricated rebar net 950 has a rectangular cross-section, the first upward displacement of the rebar at the right upper corner in the cross-section orthogonally changes the angle of the upper prefabricated rebar net 950, that is, at the left lower corner, which is second displacement.

Further, in a right-hand thread manner, when the first connecting member 120 is turned left, the first locking piece 140 is supposed to move upward, but it is supported on the front and the weight is removed, so the rebar on the first connecting member 120 is moved down.

The predetermined rebar moved downward is included in the upper prefabricated rebar net 950, so when the upper prefabricated rebar net 950 has a rectangular cross-section, the first downward displacement of the rebar at the right upper corner in the cross-section orthogonally changes the angle of the upper prefabricated rebar net 950, that is, at the right upper corner, which is second displacement.

First displacement is generated by turning right or left the first connecting members 120 coupled to one or more predetermined rebars selected in this way and second displacement that is a change in angle of the upper prefabricated rebar net 950 is correspondingly generated to incline the upper prefabricated rebar net 950 in the front-rear, orthogonal, or left-right direction, whereby verticality is achieved.

For example, assuming that a prefabricated rebar net for constructing a pillar of 1 m×1 m×9 m is provided, when a first connecting member 120 is changed in position by 1.74 cm, which is the first displacement, a second displacement of 1° is generated, and in this case, since the entire length of a rebar is 9 m, a displacement of 15.70 cmm is generated at the end of the rebar.

That is, the position of the first connecting member 120 can be precisely controlled, so the second displacement can be implemented in degree, minute, and second, and it generates proportional displacement at the end of a rebar, so it is possible to precisely correct the verticality of the upper prefabricated rebar net 950.

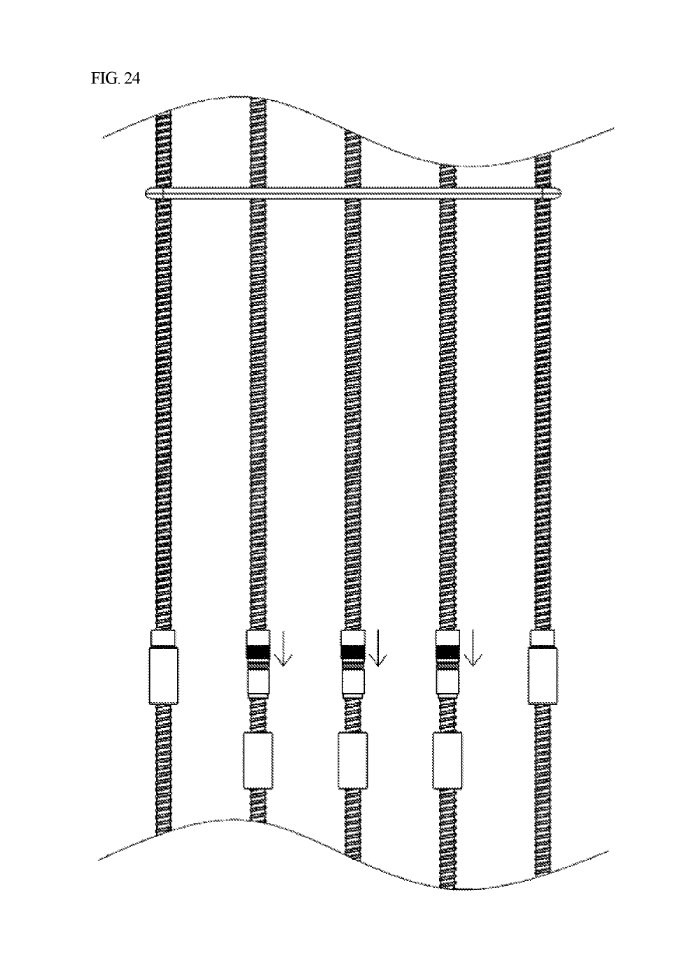

Next, referring to FIG. 23, a step (S4) of fixing the position of first connecting members 120 coupled to one or more predetermined rebars at desired positions with verticality secured, using locking sockets 160, is performed.

The verticality of the upper prefabricated rebar net 950 on a fixed floor is checked using a device for checking verticality, that is, a leveler. When the second displacement to be increased or decreased for correction is determined in this way, the position of a first connecting member 120 is changed, and when the verticality is secured, the first connecting member 120 is fixed at the position.

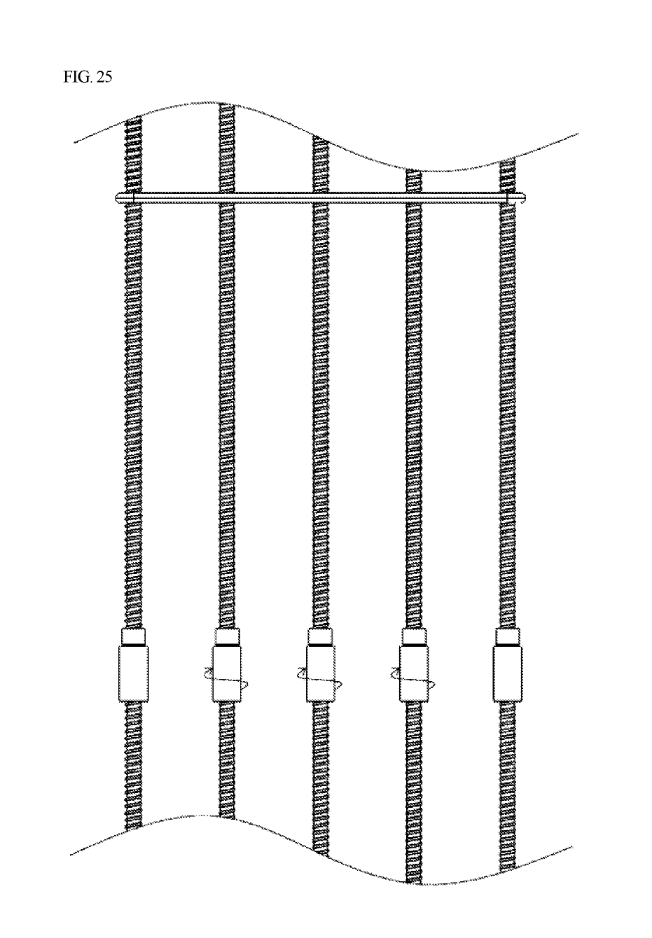

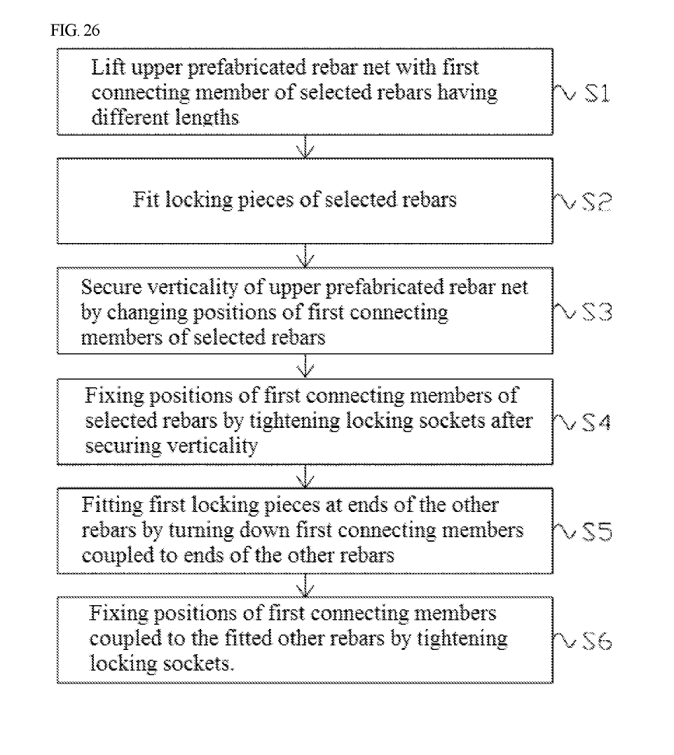

Next, referring to FIG. 24, a step (S5) of fitting the pairs of locking pieces by turning down the first connecting members 120 coupled to the ends of the other rebars is performed.

The first connecting members 120 that are turned downward are fitted after the verticality of the upper prefabricated rebar net 950 is secured and the verticality of the upper prefabricated rebar net 950 is maintained by the joints on the longitudinal bars, so the verticality of the upper prefabricated rebar net 950 is not changed.

Next, referring to FIG. 25, a step (S6) of fixing the positions of the first connecting members 120 coupled to the ends of the other rebars using the locking sockets 160 is performed.

Accordingly, precise construction is achieved by the pre-assembly method of securing verticality of longitudinal bars on the ground and absorbing construction errors, so the structural stability of the structure is secured, and accordingly, not only the longitudinal bars for a pillar, but the longitudinal bars for a beam and the longitudinal bars for a wall can be precisely placed in position without an error.

The spirit of the present invention is not limited to the embodiments, the present invention may be modified in various ways by those skilled in the art with departing from the scope of the present invention, and the modifications should be construed as being included in the present invention or equivalents of the present invention.

1. A rebar connector having a pair of locking pieces, the connector comprising:
a first rebar and a second rebar to be connected to each other with ends fitted to each other;
a first connecting member having a center hole, receiving the first rebar into the center hole from a first side, having a first coupling hole at a second side, and having a male threaded portion at a predetermined section on an outer side thereof;
a second connecting member having a center hole, receiving the second rebar into the center hole through a first side, and having a second coupling hole at a second side;
a first locking piece separately formed and coupled to the first coupling hole;
a second locking piece separately formed and coupled to the second coupling hole; and
a locking socket locked at a predetermined position on the second connecting member, covering an outer side of the second connecting member, and having a female threaded portion on an inner side to be thread-fastened to the male threaded portion of the first connecting member,
wherein an integrated joint is formed by tightening the locking socket with the first locking piece and the second locking piece fitted to each other as a pair.

2. The connector of claim 1, wherein the first locking piece and the second locking piece to be fitted to each other each have a body, a front end formed at a first end of the body, and a base end formed at a second end of the body, wherein the base end is inserted in the first coupling hole or the second coupling hole and the front ends are fitted to each other.

3. The connector of claim 2, wherein the first coupling hole and the second coupling hole respectively have a first space and a second space for absorbing displacement of the first connecting member and the second connecting member when the locking socket is tightened.

4. The connector of claim 3, wherein the first space and the second space communicate with the center holes, and sizes of the first space and the second space depend on a coupling length of the first and second connecting members and the first and second rebars.

5. The connector of claim 2, wherein front ends of the first locking pieces and the second locking pieces to be fitted to each other are flat surfaces perpendicular to an axial direction, or are a projection and a recession corresponding to the projection, respectively.

6. The connector of claim 5, wherein the projection at the front end and the recession corresponding to the projection are
multi-stepped inclined projection having a one or more of uniform sections and inclined sections longitudinally formed on an outer side and a recession corresponding to the multi-stepped inclined projection, or
a multi-stepped rectangular projection having a one or more of uniform sections and inclined sections longitudinally formed on an outer side and having an end being parallel with an axial direction, and a recession corresponding to the multi-stepped rectangular projection, or
a multi-stepped curved projection having a one or more of uniform sections and inclined sections longitudinally formed on an outer side and having a rounded end, and a recession corresponding to the multi-stepped curved projection, or
a projection having a shape selected from shapes of a cone, a frustum-cone, a cone with a rounded top, a cylinder, a polypyramid, a frustum-polyprism, a polyprism with a rounded top, a polygonal cylinder, a sphere, an elliptical sphere, a frustum-spherical shape, a frustum-elliptical sphere, a triangle, a triangle with a rounded top, a rectangle, and a rectangle with rounded edges, and a shape having an end on which a cross, a combination of a cross and a circle, or a waved colgate is formed, and a recession corresponding to the projection.

7. The connector of claim 5, wherein the recession is an axially formed through-hole.

8. The connector of claim 3, wherein the base ends of the first locking piece and the second locking piece are inserted in the first coupling hole and the second coupling hole and loosely positioned in the first space and the second space.

9. The connector of claim 6, wherein a second projection is formed on the bodies of the first locking piece or the second locking piece outward from the first space and the second space to limit an insertion depth of the first locking piece or the second locking piece, and is spaced from front ends of the first connecting member and the second connecting member to define a first gap and a second gap that adjust a length of the joint or remove initial slip.

10. The connector of claim 9, wherein a step for locking the first projections at the base ends of the first locking piece and the second locking piece is formed inside the first space and the second space, and is one or more bolts.

11. The connector of claim 9, wherein the loosely positioned base ends of the first locking piece and the second locking piece are pressed at predetermined positions by front ends of the first rebar and the second rebar.

12. The connector of claim 9, wherein the base ends of the first locking piece and the second locking piece are inserted in the center holes of the first connecting member and the second connecting member and pressed by front ends of the first rebar and the second rebar to be fitted to the first space and second space and the front ends of the first rebar and the second rebar.

13. The connector of claim 12, wherein first female threads are formed on inner sides of inlets of the first space and the second space, first male threads are formed at a predetermined section on outer sides of the first locking piece and the second locking piece, and the first male threads are inserted and thread-fastened in the inlets.

14. The connector of claim 13, wherein the first locking piece and the second locking piece are pressed between the first female threads on the inner sides of the inlets and the front ends of the first rebar and the second rebar.

15. The connector of claim 12, wherein the inner sides of the inlets of the first space and the second space and the base ends of the first locking piece and the second locking piece each have a tolerance, and the base ends of the first locking piece and the second locking piece are forcibly fitted in the inlets.

16. The connector of claim 15, wherein a mark for showing a primary insertion position is formed at a predetermined position on the base ends of the first locking piece and the second locking piece.

17. The connector of claim 15, wherein prominences and depressions are formed on the inner side of the inlet of the first space or the second space.

18. The connector of claim 9, wherein torque that is applied to tighten the locking socket changes a circumferential position of the locking socket and moves the first connecting member and the second connecting member to each other, displacement of the first connecting member and the second connecting member is absorbed by the first gap and the second gap, and the joint is formed with initial slip absorbed by the first gap and the second gap, thereby preventing initial slip of the joint.

19. The connector of claim 1, wherein the first locking piece and the second locking piece align axes of the first rebar and the second rebar and prevent initial slip of the first rebar and the second rebar in the joint.

20. The connector of claim 1, wherein the first rebar and the second rebar are threaded rebars, and female threaded portions for coupling the threaded rebars are formed in the center holes of the first connecting member and the second connecting member, respectively.

21. The connector of claim 1, wherein a female threaded portion for coupling a connecting member is formed in the center holes of the first connecting member and the second connecting member, the first rebar and the second rebar are deformed steel bars, and the male threaded portion for coupling a connecting member is formed by any one of forming set threads through form rolling after swaging at the end of the deformed steel bar, forming cut threads through cutting, or attaching a threaded connection member that is separately formed.

22. The connector of claim 1, wherein a first locking step having one or more steps is formed at the predetermined position on the second connecting member where the locking socket is locked, a second locking step having one or more steps to be locked to the first locking step is formed on the inner side of the locking socket, and the steps having one or more steps are formed with an acute angle, a right angle, or an obtuse angle, or are curved with a predetermined curvature.

23. The connector of claim 1, wherein a portion for preventing slide and allowing for easily holding with a hand is formed on the outer sides of the first connecting member, the second connecting member, and the locking socket, and the portion for preventing slide includes any one of cases when a spline is formed on the outer sides, the outer sides are knurled, the cross-sections are formed in a circle, the cross-section is formed in a polygon, a holding surface is formed at one or more positions facing each other.

24. The connector of claim 1, wherein the male threaded portion, the female threaded portion, the first female threads, the male threads, the male threaded portion for coupling a connecting member, and the female threaded portion for coupling a connecting member are composed of one or more threads, the threads have a cross-sectional shape of any one of triangle, a rectangle, an ellipse, and a circle, the threads have any one of a first class, a second class, and a third class, pitches of the threads are a pitch of a thin thread or a common thread, and the threads are left-hand threads or right-hand threads.

25. The connector of claim 1, wherein the first rebar and the second rebar are different in size.

26. A method of connecting prefabricated rebar nets using the rebar connector having a pair of locking pieces of claim 1, the method comprising:
coupling the first connecting member and the second connecting member to a first prefabricated rebar net and a second prefabricated rebar net;
fitting the locking pieces on the prefabricated rebar nets to each other by lifting and placing the first prefabricated rebar net onto the second prefabricated rebar net; and
correcting inclination of the first prefabricated rebar net by changing a position of the first connecting member or the second connecting member,
thereby connecting the prefabricated rebar nets while correcting inclination of one of the prefabricated rebar nets.

27. A method of connecting prefabricated rebar nets using the rebar connector of claim 1, the method comprising:
coupling the second locking pieces and the second connecting members to a lower prefabricated rebar net that is fixed, coupling the first locking pieces and the first connecting members to an upper prefabricated rebar net, and lifting and placing down the upper prefabricated rebar net with the first locking pieces and the first connecting members, which are coupled to a end of one or more rebars selected in a same cross-section of the upper prefabricated rebar net, having different lengths;
fitting the first locking pieces coupled to the ends of the rebars selected in cross-section of the upper prefabricated rebar net;
securing verticality by correcting inclination of the upper prefabricated rebar net by changing the positions of the first connecting members coupled to the fitted first locking pieces;
fixing positions of the first connecting members by tightening locking sockets after securing the verticality;
fitting the locking pieces coupled to the other rebars by turning down the first connecting members at the ends of the other rebars while maintaining the verticality; and
fixing positions of the first connecting members turned down at the ends of the other rebar by tightening locking sockets,
thereby connecting the prefabricated rebar nets while correcting inclination of one of the prefabricated rebar nets.

28. The method of claim 27, wherein the rebars selected in the cross-section of the upper prefabricated rebar net are any one of:
reference rebars disposed at four corners and arranged in an X-shape or a +-shape when the cross-section of the upper prefabricated rebar net is a rectangle;
reference rebars disposed at corners when the cross-section of the upper prefabricated rebar net is a polygon except for a rectangle; and
reference rebars disposed at quadrantal positions when the cross-section of the upper prefabricated rebar net is a circle.
